(19) United States
(12) Patent Application Publication
(10) Pub. No.: US 2017/0249076 A1
(43) Pub. Date: Aug. 31, 2017

(54) USER INTERFACES FOR PRESENTING CONTENT ITEMS TO USERS

(71) Applicant: Cole Cameron Smith, Star, ID (US)

(72) Inventor: Cole Cameron Smith, Star, ID (US)

(21) Appl. No.: 15/293,742

(22) Filed: Oct. 14, 2016

Related U.S. Application Data
(60) Provisional application No. 62/300,654, filed on Feb. 26, 2016.

(51) Int. Cl. G06F 3/0484; G06F 3/0488; G06T 19/00; G06F 3/0485

(52) U.S. Cl. CPC G06F 3/04847; G06F 3/0485; G06F 3/04883; G06T 19/006

(57) ABSTRACT

Methods, systems, and apparatus, including computer programs encoded on computer storage media, for presenting content items to users. One of the methods includes within a user interface that comprises at least one of: a single window or a single tab of a web browser or an augmented reality environment or a virtual reality environment, displaying one or more graphical units each containing one or more items, each of the items comprising a content item or a control, the items of each of the graphical units being associated with a particular application, at least two of the graphical units being displayed simultaneously at times, the at least two graphical units being displayed in respective positions in a horizontal array in the user interface, and in response to a user invoking one of the content items or controls of one of the graphical units, altering a graphical display characteristic of another one of the graphical units.

### BACKGROUND

This specification relates to user interfaces for presenting content items to users.

Various user interfaces exist for presenting content items, e.g., text segments, images, or video clips, to users and allowing users to interact with the presented content items. However, different users may be using user devices with different display capabilities to attempt to view the same content items. For example, one user may be accessing a web site through a web browser on a smartphone while another user may be accessing the same web site through a web browser on a laptop computer. Thus, it may be difficult to use the same user interface to effectively display content items to users on different user devices. For example, a user interface that is effectively presented on one kind of user device may not be effective when presented on a different kind of user device, e.g., one that has a different display size.

### SUMMARY

This specification describes technologies that relate to user interfaces for presenting content items to users.

In general, in an aspect, there is a computer-implemented method for use with one or more processors; memory; and one or more programs stored in the memory and configured to be executed by the one or more processors. This aspect of the method includes the following features: A. Within a user interface that includes at least one of: a single window or a single tab of a web browser or an augmented reality environment or a virtual reality environment, displaying one or more graphical units each containing one or more items, each of the items including a content item or a control, the items of each of the graphical units being associated with a particular application; B. At least two of the graphical units are displayed simultaneously at times; C. The at least two graphical units are displayed in respective positions in a horizontal array in the user interface; D. In response to a user invoking one of the content items or controls of one of the graphical units, a graphical display characteristic of another one of the graphical units is altered. Other combinations of two or more but fewer than all of features A through D may also be used.

Implementations may include one or any combination of two or more of the following features or in combination with any one or more of the features A through D:

E. Each of the positions can accommodate zero or one of the graphical units at a given time. F. Successive relationships of respective graphical units to positions in the horizontal array at successive times are determined at least in part by successive actions of a user with respect to content items or controls of the graphical units. G. In response to the user invoking a control of one of the graphical units, causing the one graphical unit to occupy and then remain in a particular position in the horizontal array. H. The particular position includes the position occupied by the graphical unit when the user invokes the control. I. The particular position includes a predetermined position in the horizontal array. J. In response to the user invoking a control of the user interface, again the one graphical unit is allowed to change positions in the horizontal array. K. If the particular position holds another graphical unit at the time when the user invokes the control, that other graphical unit is relocated to the position held by the one of the graphical units. L. In response to an action by the user or by the user interface, causing one of the graphical units to be moved to a particular position of the horizontal array associated with recently closed graphical units. M. In response to a user invoking a feature of the user interface, restoring the graphical unit from the position of the horizontal array associated with recently closed graphical units. N. Causing the amount of space occupied by the position of the horizontal array associated with recently closed graphical units to be smaller horizontally than the space occupied by other positions of the horizontal array. O. The graphical unit that occupies the position of the horizontal array associated with recently closed graphical units is displayed to give the user a visual cue that the graphical unit is no longer part of the main portion of the horizontal array. P. The visual cue includes treatment of at least one of perspective, opacity, or saturation. Q. The visual cue includes removing the graphical unit from the user interface. R. The graphical unit is removed based on the amount of available horizontal space. S. The user interface includes an augmented reality or virtual reality user environment in which the positions are arrayed on a curve oriented across a visual field of the user. T. The positions include one or more positions that are associated with recently closed graphical units. U. The positions that are associated with recently closed graphical units appear at opposite ends of the curve within the visual field of the user. V. In response to a user invoking a control of the user interface to cause a graphical unit to be closed or in response to a lack of sufficient space in the user interface, the graphical unit is moved to one of the positions associated with recently closed graphical units. W. In response to the user invoking a control of the user interface to cause a graphical unit to be closed or in response to a lack of sufficient space in the user interface, the graphical unit is removed from the array of positions. X. In response to the user invoking a control of the user interface to cause a graphical unit to be closed or in response to a lack of sufficient space in the user interface, the graphical unit is replaced by a text link or other visible element visible below the curve within the visual field in which the graphical units are displayed. Y. The graphical units include columns. Z. The graphical units include rectilinear units. AA. At least some of the graphical units are, at least at times, taller than they are wide. AB. The altering of the graphical display characteristic of another one of the graphical units includes causing the other graphical unit to be displayed. AC. The causing the other graphical unit to be displayed includes causing the other graphical unit to be displayed immediately to the right of or immediately to the left of the one of the graphical units. AD. The altering a graphical display characteristic of another one of the graphical units includes causing the other graphical unit to no longer be displayed. AE. The altering a graphical display characteristic of another one of the graphical units includes altering a graphical prominence of the other graphical unit. AF. The altering the graphical prominence of the other graphical unit includes enlarging the other graphical unit. AG. The enlarging the other graphical unit includes causing the other graphical unit to obscure at least part of an adjacent graphical unit. AH. The altering a graphical prominence of the other graphical unit includes reducing the size of the other graphical unit. AI. The altering a graphical prominence of the other graphical unit includes reducing the graphical clarity of the other graphical unit. AJ. The altering a graphical prominence of the other graphical unit includes relocating the other graphical unit out of the horizontal array. AK. The altering a graphical display characteristic of another one of the graphical units includes moving the other graphical unit to a different position within the horizontal array. AL. Only one of the graphical units of the array is displayed on a display surface at a given time. AM. A number of the graphical units of the array are displayed on a display surface at a given time, the number depending on the available space on the display surface. AN. A number of the graphical units of the array is displayed on a display surface at a given time, the number depending on the available space of the user interface. AO. A number of the graphical units of the array are displayed on a display surface at a given time, the number depending on the size of the device on which the user interface is provided. AP. All of the graphical units are associated with a particular application. AQ. At least two of the graphical units are associated respectively with different particular applications. AR. Each of the graphical units includes a bounding perimeter. AS. The bounding perimeter is visible. AT. The bounding perimeter is rectilinear. AU. The particular application includes a social networking application. AV. The particular application includes a photograph management application. AW. When three or one of the content items is invoked by a user, an additional graphical unit is displayed that includes the content item presented more prominently.

In general, in an aspect, there is a computer-implemented method for use with one or more processors; memory; and one or more programs stored in the memory and configured to be executed by the one or more processors. This aspect of the method includes the following features: A. A user interface includes at least one of: a single window or a single tab of a web browser or an augmented reality environment or a virtual reality environment; B. One or more graphical units each containing one or more items are displayed; C. Each of the items includes a content item or a control D. The items of each of the graphical units are associated with a particular application E. At least two of the graphical units are displayed simultaneously at times; F. The at least two graphical units are displayed in respective positions in a horizontal array in the user interface; G. In response to a user invoking a feature of the user interface, two or more of the graphical units are caused to be treated as a group. Other combinations of two or more but fewer than all of features A through G may also be used.

Implementations may include one or any combination of two or more of the following features or in combination with any one or more of the features A through G. H. Treating the graphical units as a group includes saving them as a group. I. Treating the graphical units as a group includes responding to a feature of the user interface that is invoked by a user by taking an action with respect to all of the graphical units that belong to the group.

In general, in an aspect, there is a computer-implemented method for use with one or more processors; memory; and one or more programs stored in the memory and configured to be executed by the one or more processors. This aspect of the method includes the following features: A. At a server, a server application is operated to generate and serve content and controls associated with a user application as graphical units to devices that have display screens. B. The devices include handheld mobile devices, non-handheld mobile devices, and non-mobile devices, the graphical units having positions in a horizontal array. C. The graphical units are generated and served in a manner that enables each of the devices to which the graphical units are served automatically to display, at a given time, a number of graphical units in the horizontal array that depends on the size of the display screen of the device. D. The server application is initially created to generate and serve content and controls associated with the user application as graphical units to handheld mobile devices. E. The created server application is used to serve the content and controls associated with the user application in the same graphical units to non-handheld devices. F. The graphical units are served through single windows or single tabs of web browsers or augmented reality environments or virtual reality environments running on the devices. G. The graphical units are generated and served in a manner that enables each of the devices to alter the number of graphical units that are displayed in the horizontal array at a given time based on available space on display screens of the devices or on available space in dynamically alterable sizes of windows or tabs of web browsers or augmented reality environments or virtual reality environments running on the devices. Other combinations of two or more but fewer than all of features A through G may also be used.

In general, in an aspect, there is a computer-implemented method for use with one or more processors; memory; and one or more programs stored in the memory and configured to be executed by the one or more processors. This aspect of the method includes the following features: A. Within a user interface that includes at least one of: a single window or a single tab of a web browser or an augmented reality environment or a virtual reality environment, two or more graphical units are displayed in respective positions in a horizontal array in the user interface; B. Each of the graphical units contains one or more items each including a content item or a control; C. In response to a user invoking one of the content items or controls of one of the graphical units or another control of the user interface, at least one of the position, number, order, or prominence of display of at least one of the two or more graphical units is graphically altered within the user interface. Other combinations of two or more but fewer than all of features A through C may also be used.

Implementations may include one or any combination of two or more of the following features or in combination with any one or more of the features A through C. D. Graphically altering includes displaying an additional graphical unit. E. The additional graphical unit is displayed in the center of the horizontal array. F. The additional graphical unit is displayed adjacent to the graphical unit that contained an invoked content item or control. G. The additional graphical unit is displayed to the right or left of the graphical unit that contained the invoked content item or control. H. Graphically altering includes moving one of the graphical units to the right of the rightmost graphical unit of the array or to the left of the leftmost graphical unit of the array. I. Graphically altering includes reducing or enhancing the displayed clarity or size or both of one of the graphical units. J. Graphically altering includes not displaying one of the displayed graphical units. K. Graphically altering includes moving a graphical unit out of the array.

Other aspects include the following:
A computer implemented system including one or more processors; memory; one or more programs stored in the memory and configured to be executed by the one or more processors, the one or more programs providing: a user interface that includes at least one of: a single window or a single tab of a web browser or an augmented reality environment or a virtual reality environment, one or more displayed graphical units each containing one or more items, each of the items including a content item or a control, the items of each of the graphical units being associated with a particular application, at least two of the graphical units at times being displayed simultaneously in respective positions in a horizontal array in the user interface, and a graphical display characteristic of one of the graphical units that changes in response to a user invoking one of the content items or controls of one of the graphical units.
A non-transitory medium bearing instructions to cause a machine that includes one or more processors; memory; and one or more programs stored in the memory to, among other things: within a user interface that includes at least one of: a single window or a single tab of a web browser or an augmented reality environment or a virtual reality environment, display one or more graphical units each containing one or more items, each of the items including a content item or a control, the items of each of the graphical units being associated with a particular application, at least two of the graphical units being displayed simultaneously at times, the at least two graphical units being displayed in respective positions in a horizontal array in the user interface, and in response to a user invoking one of the content items or controls of one of the graphical units, alter a graphical display characteristic of another one of the graphical units.
A computer-implemented system including one or more processors; memory; one or more programs stored in the memory and configured to be executed by the one or more processors, the one or more programs providing: a user interface that includes at least one of: a single window or a single tab of a web browser or an augmented reality environment or a virtual reality environment, one or more graphical units each containing one or more items, each of the items including a content item or a control, the items of each of the graphical units being associated with a particular application, at least two of the graphical units at times being displayed simultaneously in respective positions in a horizontal array in the user interface, and a group including two or more of the graphical units, the group being treated as a group in response to a user invoking a feature of the user interface.
A non-transitory medium bearing instructions to cause a machine that includes one or more processors; memory; and one or more programs stored in the memory to, among other things: within a user interface that includes at least one of: a single window or a single tab of a web browser or an augmented reality environment or a virtual reality environment, display one or more graphical units each containing one or more items, each of the items including a content item or a control, the items of each of the graphical units being associated with a particular application, display at least two of the graphical units at times simultaneously in respective positions in a horizontal array in the user interface, and in response to a user invoking a feature of the user interface, cause two or more of the graphical units to be treated as a group.
A computer-implemented system including one or more processors; memory; one or more programs stored in the memory and configured to be executed by the one or more processors, the one or more programs providing: for a server to generate and serve content and controls associated with a user application as graphical units to devices that have display screens, the devices including handheld mobile devices, non-handheld mobile devices, and non-mobile devices, the graphical units having positions in a horizontal array, the graphical units being generated and served in a manner that enables each of the devices to which the graphical units are served automatically to display, at a given time, a number of graphical units in the horizontal array that depends on the size of the display screen of the device.
A non-transitory medium bearing instructions to cause a machine that includes one or more processors; memory; and one or more programs stored in the memory to, among other things: at a server, operate a server application to generate and serve content and controls associated with a user application as graphical units to devices that have display screens, the devices including handheld mobile devices, non-handheld mobile devices, and non-mobile devices, causing the graphical units to have positions in a horizontal array, generating and serving the graphical units in a manner that enables each of the devices to which the graphical units are served automatically to display, at a given time, a number of graphical units in the horizontal array that depends on the size of the display screen of the device.
A computer-implemented system including one or more processors; memory; one or more programs stored in the memory and configured to be executed by the one or more processors, the one or more programs providing: a user interface that includes at least one of: a single window or a single tab of a web browser or an augmented reality environment or a virtual reality environment, two or more graphical units in respective positions in a horizontal array in the user interface, each of the graphical units containing a one or more items each including a content item or a control, and a graphically altered position, number, order, or prominence of display of at least one of the two or more graphical units within the user interface in response to a user invoking one of the content items or controls of one of the graphical units or another control of the user interface.
A non-transitory medium bearing instructions to cause a machine that includes one or more processors; memory; and one or more programs stored in the memory to, among other things: within a user interface that includes at least one of: a single window or a single tab of a web browser or an augmented reality environment or a virtual reality environment, display two or more graphical units in respective positions in a horizontal array in the user interface, each of the graphical units containing a one or more items each including a content item or a control, and in response to a user invoking one of the content items or controls of one of the graphical units or another control of the user interface, graphically alter at least one of the position, number, order, or prominence of display of at least one of the two or more graphical units within the user interface.

Particular embodiments of the subject matter described in this specification can be implemented so as to realize one or more of the following advantages.

Using the user interface described in this specification, content items associated with a particular application can be effectively presented on many different kinds of user devices having many different display sizes. In particular, because the number of positions in a horizontal array that are displayed in the user interface when presented on a device and, optionally, the widths of the displayed positions are adaptable based on available space on the display screen of the device or on available space in dynamically alterable sizes of windows or tabs of web browsers or augmented reality environments or virtual reality environments running on the device, content items associated with a server application can be effectively viewed and interacted with in the user interface by a user of the device regardless of the size of the display of the device or of the amount of display space currently allocated to the user interface.

Additionally, because the device is configured to add new graphical units to the user interface, move existing graphical units to different positions in the horizontal array, and remove some or all of the existing graphical units from being displayed in the user interface in response to certain user inputs interacting with the user interface, the user is able to navigate effectively among the various content items that are associated with the server application and, optionally, content items associated with other applications.

Additionally, by initially creating the server application to generate and serve content and controls associated with the user application to handheld mobile devices as graphical units in the user interface, the created server application can later be used to serve the content and controls associated with the user application to non-handheld devices as the same graphical units. That is, the created server application can later be used to serve the content and controls associated with the user application to non-handheld devices with few or no changes to the code of the created server application. Thus, serving content as described in this application can save labor time and costs for the technology teams responsible for creating the server application, maintaining the server application, and syncing changes between mobile and web versions of a server application. In fact, for some applications, creating the server application as described in this specification may allow the content associated with the application to be effectively interacted with on non-handheld devices when it otherwise would not have been feasible for the technology team or teams responsible to develop a separate web version of the application.

Additionally, by creating the server application in this manner, the user experience of users who use both a web and a mobile version of a given application can be enhanced by allowing the users to interact with the same user interface on both a handheld device and a non-handheld device. Thus, the user experience may be more intuitive and more engaging as the user transitions between devices.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1-16 illustrate example user interfaces.

FIG. 17 shows an example user device and an example server system.

FIG. 18 is a flow diagram of an example process for altering a display characteristic of one or more graphical units in a user interface.

FIG. 19 is a flow diagram of an example process for serving content and control data to a user device.

FIG. 20A is a flow diagram of an example process for altering a user interface in response to a user input identifying a graphical unit to be closed.

FIG. 20B is a flow diagram of an example process for closing a graphical unit.

FIG. 21A is a flow diagram of an example process for altering a user interface in response to a user input opening a new graphical unit from a displayed graphical unit.

FIG. 21B is a flow diagram of an example process for adding a new graphical unit to the user interface in response to a user invoking a particular displayed graphical unit.

FIG. 22 is a flow diagram of an example process for displaying a new graphical unit in the user interface in response to a user invoking a control that is not contained in a graphical unit.

FIG. 23 is a flow diagram of an example process for pinning a graphical unit to the first position in the horizontal array.

Like reference numbers and designations in the various drawings indicate like elements.

### DETAILED DESCRIPTION

This specification generally describes a user interface for presenting graphical units containing items, e.g., content items and controls, to a user on a user device. In particular, the user interface allows the user to navigate through and interact with items associated with one or more applications by displaying, at times, multiple graphical units that contain the items to be presented to the user. For example, the graphical units may be columns within the user interface. As the user interacts with the user interface to invoke content items and controls contained in the graphical units, the user device may add new graphical units to the user interface and move existing graphical units to different positions in the user interface or remove some or all of the existing graphical units from the user interface.

For example, in some implementations, some or all of the items presented in the user interface may be associated with a social networking system. In these implementations, the content items and controls may include information associated with user profiles of users of the social networking system, e.g., images, videos, links to web resources, and so on. Thus, each user profile may be a collection of content items and controls associated with a given user. The user can navigate through user profiles and their associated content by interacting with the user interface displayed on the user device.

As another example, in some implementations, some or all of the items presented in the user interface may be associated with a photograph management system. In these implementations, the content items may include photographs and videos associated with the user and, optionally, with other users of the photograph management system. The user can navigate through photographs and other content managed by the photograph management system by interacting with the user interface displayed on the user device.

In some implementations, the graphical units and the entire user interface in which the graphical units are displayed are associated with a particular application. For example, the user interface and, in turn, the items in the graphical units may be provided for presentation on the user device by a system executing the particular application. In some other implementations, the items in the graphical units may be associated with multiple applications. For example, the particular application may obtain content items from an external application and the system executing the particular application may provide the content items for presentation in a graphical unit in the user interface, e.g., along with content items associated with the particular application.

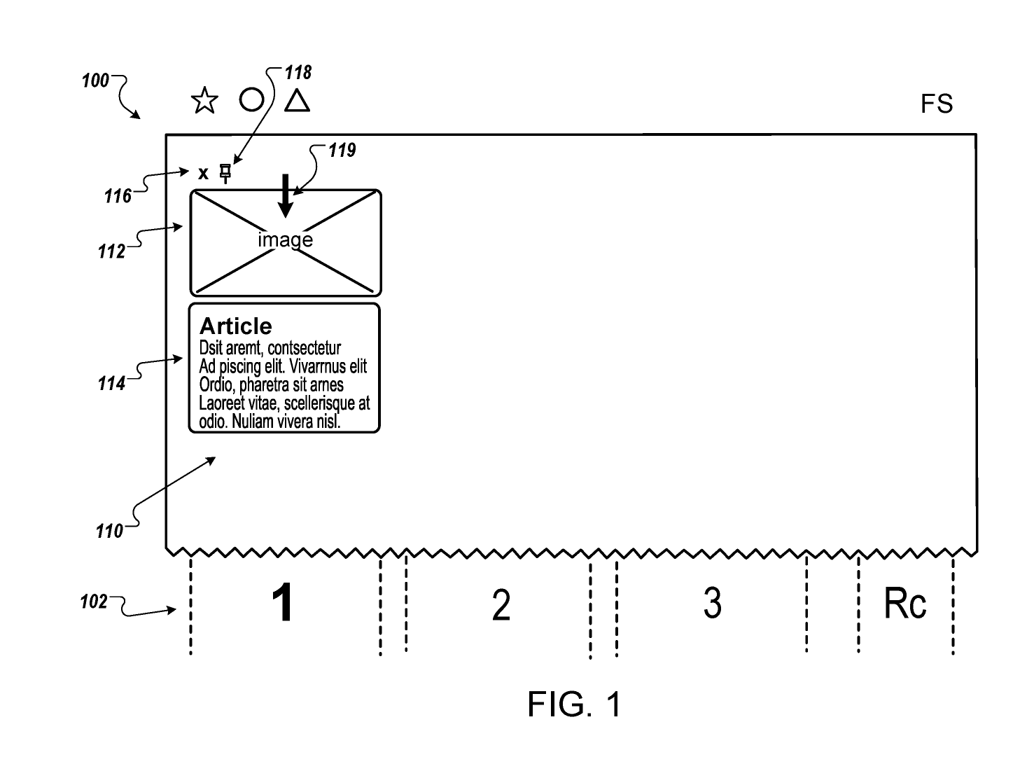

FIG. 1 illustrates an example user interface 100 that includes a first graphical unit 110 at a first position in a horizontal array 102. The example user interface 100 is displayed on a user device, e.g., a smartphone, a tablet computer, a laptop computer, or other user computer. For example, the user interface 100 may be displayed in a window or a tab of a web browser executing on the user device. When the user device is a mobile device, e.g., a smartphone or a tablet computer, the user interface 100 may be displayed in a web browser window or tab or by a special-purpose mobile application executing on the mobile device.

The horizontal array 102 includes multiple positions, with the number of positions in the horizontal array 102 defining the maximum number of graphical units that can be displayed simultaneously in the user interface 100. In the example of FIG. 1, the horizontal array 102 includes four positions: a first position, a second position, a third position, and a recently closed (“Rc”) position. However, the number of positions in the horizontal array 102 and, in turn, the maximum number of graphical units that can be displayed in the user interface 100 simultaneously will generally depend on the display capabilities of the user device and on the current portion of the display area of the user device that is being allocated to the user interface 100.

For example, when the user interface 100 is being displayed in an application window, e.g., a window or a tab of a web browser, the user device may adapt the number of positions in the horizontal array to the available horizontal window space allocated to the user interface 100. For example, when the window is narrow, only one position, i.e., only the first position, may be included in the horizontal array. As the window is widened, two and then three positions may be included.

As another example, the number of positions in the horizontal array may differ by device and, in particular, by device display size. For example, when the user interface 100 is being presented on a smartphone, only one position may be supported, but when the user interface 100 is being presented on a tablet, two or more columns may be supported in either the horizontal or the vertical orientation.

Additionally, the widths of the positions in the array and, in turn, the widths of the graphical units displayed in the positions, may not be fixed. Instead, the user device may adjust the widths according to available horizontal display space. For example, when a tablet computer is held horizontally, two positions may be included in the array and each position can have a first width, but when the tablet computer is rotated to a vertical orientation, the two columns still appear, but may narrow to adapt to the narrower available horizontal space.

While the horizontal array 102 and the positions in the horizontal array 102 are shown in FIG. 1 for ease of description, the horizontal array 102 is generally not depicted as part of the user interface 100 when the user interface is presented on a user device.

Moreover, in the example of FIG. 1 and in the description that follows, the first position in the horizontal array 102 is the leftmost position in the array and subsequent, i.e., higher, positions incrementally move to the right across the user interface 100. However, one of ordinary skill in the art would appreciate that the techniques described in this specification can also be used with a right-to-left user interface, i.e., a user interface in which the first position is the rightmost position in the array and subsequent positions incrementally move to the left across the user interface 100.

In the example of FIG. 1, the first graphical unit 110 contains two content items, an image content item 112 and an article content item 114, and two controls, a close control 116 and a pin control 118. The functionality of the close control and the pin control will be described in more detail below.

A user can invoke one of the content items or the controls in the first graphical unit 110 to interact with the user interface 100 while it is being displayed on the user device. Generally, in response to the user invoking one of the controls or one of the content items, the user device modifies the user interface 100 to modify a graphical display characteristic of the first graphical unit 110, a graphical display characteristic of another graphical unit, or both. As illustrated in FIG. 1, a user has submitted an input 119 invoking the image content item 112 in the first graphical unit 110. For example, image content item 112 may be a thumbnail of full-sized image and the user may invoke the thumbnail to view the full-sized image. The input 119 may be any input that is an appropriate input modality for the user device on which the user interface 100 is being displayed. For example, the input 119 may be a selection with an input device, e.g., a mouse click, or a touch input on a touchscreen display.

In response, the user device can modify the user interface 100 by altering a graphical display characteristic of a second graphical unit, i.e., by causing the second graphical unit to be displayed in the user interface 100 even though it was not displayed prior to the user invoking the image content item 112. In particular, the second graphical unit, when displayed, is displayed in a position in the horizontal array that is adjacent to the invoked graphical unit—in this case, to the right of the invoked graphical unit.

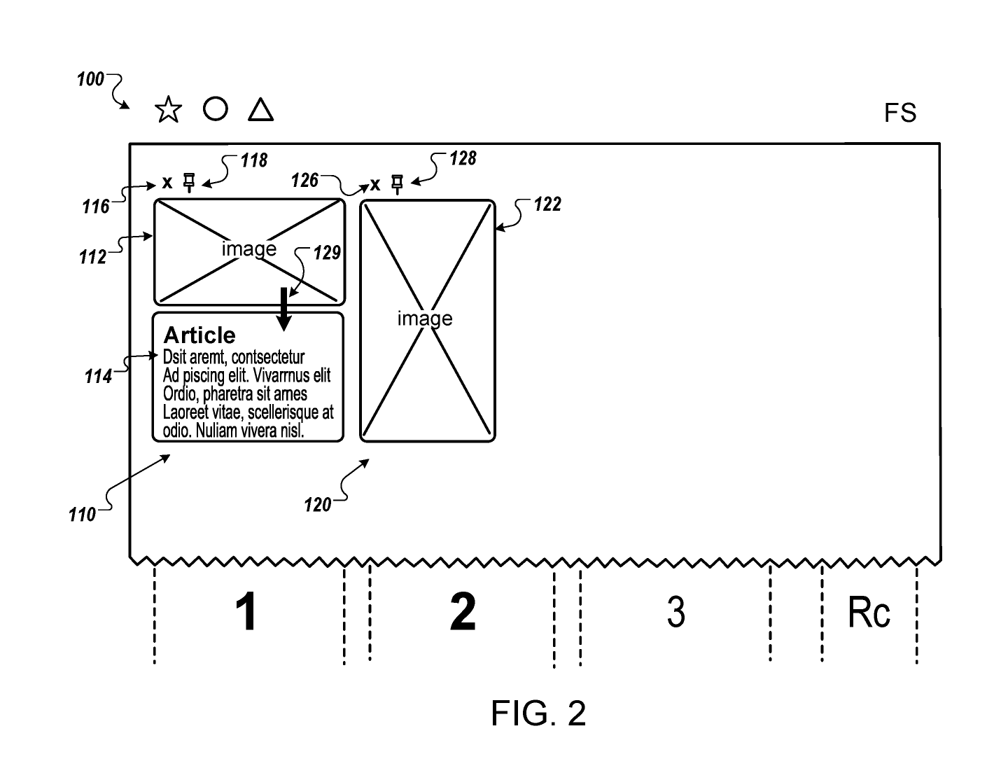

FIG. 2 illustrates the example user interface 100 including a second graphical unit 120 at a second position in the horizontal array. In particular, the user device has modified the user interface 100 to display the second graphical unit 120 in the second position in the horizontal array while still displaying the first graphical unit 110 in the first position in the horizontal array in response to the input 119 invoking the image content item 112 as described above with reference to FIG. 1.

As is evident from FIG. 2, each of the graphical units 110 and 120 is a column having a bounding perimeter that is rectilinear, although the entire rectilinear outline of each graphical unit is not depicted in the user interface. In some other implementations, however, the bounding perimeters of the graphical units may be other than rectilinear, e.g., in a virtual reality or augmented reality environment, where the graphical units may be volumes rather than columns.

Additionally, while in the example of FIG. 2 the boundary between the graphical units 110 and 120 is not visible, in some implementations, all of or a portion of the bounding perimeter of one or more of the graphical units may be visually demarcated in the user interface 100.

The second graphical unit 120 includes an image content item 122, a close control 126, and a pin control 128. Because the second graphical unit 120 was displayed in response to the user invoking the image content item 112, the image content item 122 is an enlarged version of the image content item 112. For example, if the image content item 112 is a cropped version of an image, the image content item 122 may be the full-size image. Thus, the user can view an enlarged version of the image while still being able to view the first graphical unit 110, e.g., so that if the user desires to further interact with the first graphical unit 110, the user does not need to submit additional input or navigate away from viewing the image content item 122 in order to do so. In particular, the user can further interact with the first graphical unit 110 while the second graphical unit 120 is being displayed by submitting an input 129 on the article content item 114. In response, the user device can modify the user interface 100 by modifying a graphical display characteristic of the second graphical unit 120 and of a third graphical unit that has not yet been displayed.

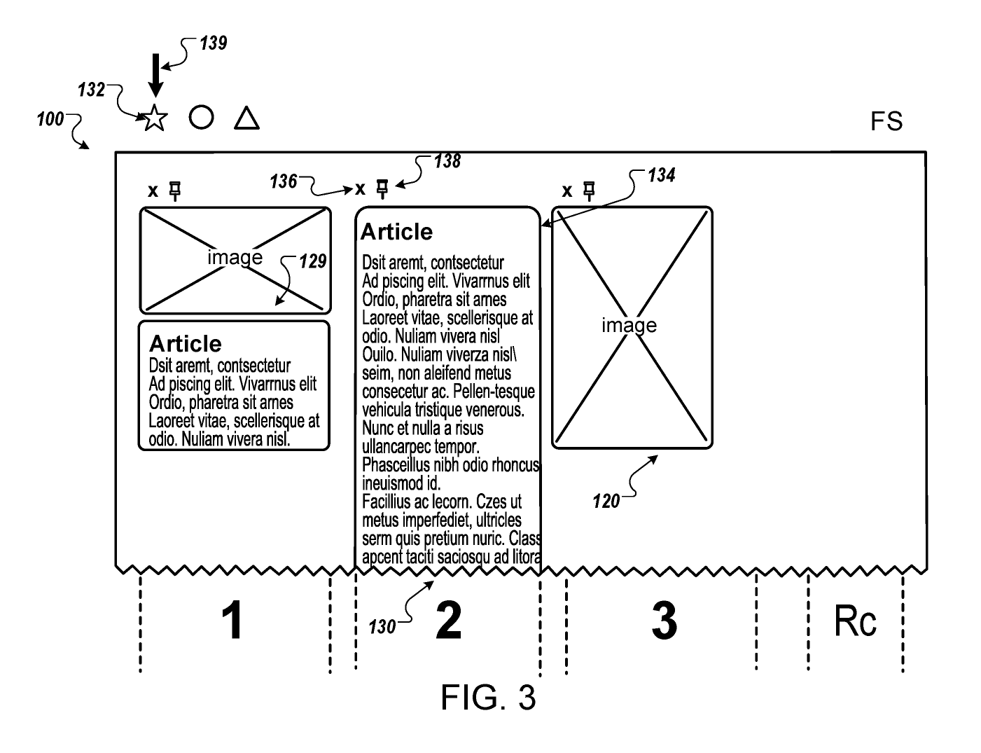

FIG. 3 illustrates the example user interface 100 with the second graphical unit 120 having been moved to a third position in the horizontal array. In particular, the user device has modified the user interface 100 to display a third graphical unit 130 in the second position in the horizontal array where the second graphical unit 120 had previously been displayed and to push the second graphical unit 120 to the third position in the horizontal array. In the example of FIG. 3, the first graphical unit 110 remains in the first position because it is the graphical unit that was invoked to cause the third graphical unit 130 to be displayed, the third graphical unit 130 is displayed in the second position to be proximate to the graphical unit that was invoked to cause it to be displayed, and each graphical unit in a position higher than the position of the first graphical unit 110 is pushed to the next highest position in the array, resulting in the second graphical unit 120 being pushed to the third position. When pushing a graphical unit to the next highest position in the array causes the graphical unit to be relocated out of the array, the graphical unit is no longer displayed in the user interface 100.

The third graphical unit 130 includes an article content item 134, a close control 136, and a pin control 138. In particular, because the third graphical unit 130 was displayed in response to the user invoking the article content item 114, the article content item 134 is an enlarged version of the article content item 114. For example, if the article content item 114 is a snippet from or a summary of a full article, the article content item 134 may be the full article.

The user can also interact with the user interface 100 to cause the graphical display characteristics of the graphical units to be modified by invoking controls that are not contained in any of the displayed graphical units. For example, the user can submit an input 139 invoking a star control 132 from a menu of controls. The star control 132 may be associated with a starred graphical unit that is not currently being displayed in the user interface 100. In some implementations, in response to the star control 132 being invoked by the user, the mobile device displays the starred graphical unit in a predetermined position, e.g., in the first position, in the horizontal array, and all graphical units displayed in positions higher than the predetermined positions are pushed to the next highest position. In some implementations, the user interface 100 includes multiple controls that are not contained in any of the displayed graphical units that, when invoked, cause the user device to display a respective predetermined graphical unit.

As another example, the user interface may include a navigation bar that, when invoked, results in a pop-over user interface element being displayed. In response to the user invoking a notification within the pop-over element, the user device opens a user interface element, e.g., a graphical unit, associated with the invoked notification. In some implementations, the user device displays the graphical unit in the highest empty non-recently closed position in the horizontal array. If there is already a graphical unit displayed in the highest non-recently closed position in the horizontal array, the user device displays the graphical unit in the highest non-recently closed position and moves the graphical unit previously displayed in the highest non-recently closed position to the recently closed position.

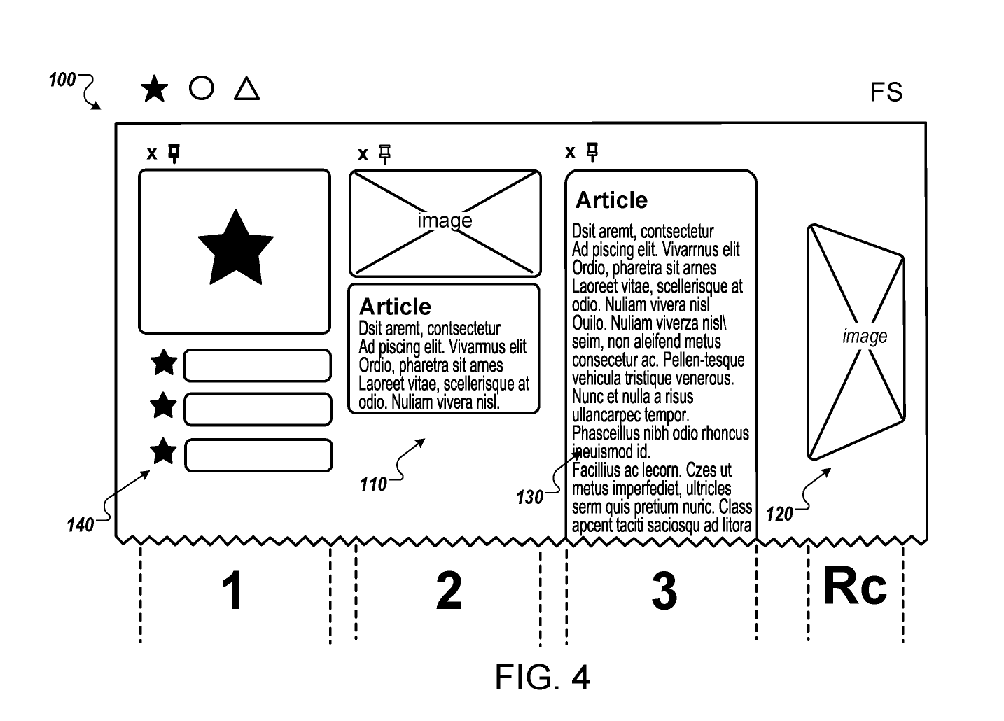

FIG. 4 illustrates the example user interface 100 with a starred graphical unit 140 being displayed in the first position in the horizontal array. As a result of the starred graphical unit 140 being displayed in the first position, each previously displayed graphical unit has been pushed to the next highest position in the array, i.e., shifted to the right in the user interface 100. Thus, the graphical element 110 is now displayed in the second position in the horizontal array, the graphical element 130 is now displayed in the third position in the horizontal array, and the graphical element 120 is now displayed in the recently closed position in the horizontal array.

The recently closed position in the horizontal array is the position a graphical unit is moved to when the graphical unit is manually closed by a user, e.g., as described in more detail below, or when the graphical unit is closed automatically due to the rules of graphical unit movement, e.g., when the graphical unit is pushed into the recently closed position as a result of a new graphical unit being displayed in the user interface 100. By placing the graphical unit in the recently closed position rather than removing the graphical unit from being displayed in the user interface 100 immediately, the user device allows the user to restore a recently closed graphical unit to a different position in the user interface 100 by invoking that graphical unit, as will be described in more detail below.

In some implementations, the user device displays the graphical unit that is in the recently closed position or, if the user interface supports more than one recently closed position, any graphical unit that is at any of the recently closed positions, with an altered graphical prominence relative to the graphical units in the non-recently closed positions in the array to distinguish the recently closed position or positions from the non-recently closed positions. For example, in FIG. 4, the graphical unit 120 is displayed with a vanishing perspective such that the graphical unit is oriented toward an invisible vanishing point beyond the edge of the interface. In other examples, graphical units in the recently closed position may have their graphical prominence reduced when moved to the recently closed position, e.g., by being displayed as partially opaque, reduced in saturation, or otherwise being altered to convey to the user that the graphical unit is departing the interface. In some implementations, the width of the recently closed position is less than the width of the other positions in the horizontal array.

In some implementations, the recently closed position is only displayed when certain criteria are met. For example, when the available horizontal display space allocated to the display is insufficient, the recently closed position may not be displayed. As another example, the recently closed position may only be displayed when there are two or more other positions in the horizontal array. When no recently closed position is displayed, graphical units that are manually closed by a user or are closed automatically are immediately removed from display in the user interface 100 by the user device. Additionally, in some implementations, there may be multiple recently closed positions rather than a single recently closed position in the horizontal array.

Additionally, in some implementations, a safeguard may be implemented in the user interface 100 to prevent users from losing unsaved work that is included in a content item that is being moved into the recently closed position. For example, in some implementations, if the user has created unsaved content in a graphical unit that is automatically moved to the recently closed position, the user device can display or generate a warning indicator, e.g., a flag, popup, or alert, to alert the user to the need to save the content. The alert may appear either upon the graphical unit with unsaved content entering the recently closed position, or upon the unsaved content being permanently lost, i.e., upon the graphical unit being removed from the horizontal array. In the latter case, the alert would allow the user to halt the recently closed graphical unit from being removed and prevent its content from being permanently lost. As another example, graphical units with unsaved content may be prevented from entering the recently closed position unless the user manually closes the graphical unit with unsaved content, i.e., graphical units with unsaved content would be prevented from being automatically closed as a result of graphical unit movement rules.

In some implementations, the user interface 100 includes a control that allows the user to enlarge a content item contained in one of the graphical units being displayed in the user interface 100, i.e., to increase the size of the displayed content item to a size that exceeds the size allotted to the displayed content item in the graphical unit. In particular, in some implementations, a respective control is displayed in association with each of the content items being displayed in the user interface 100 that is capable of being enlarged. In some other implementations, a single expansion control is displayed that, after being invoked by the user, allows the user to invoke a displayed content item to cause the content item to be enlarged. Additionally, in some implementations, instead of or in addition to the one more controls, when the user interface is displayed on a user device that supports swipe inputs or other gesture input, a predetermined gesture input, e.g., a swipe up, on an eligible content item results in the user device expanding the content items.

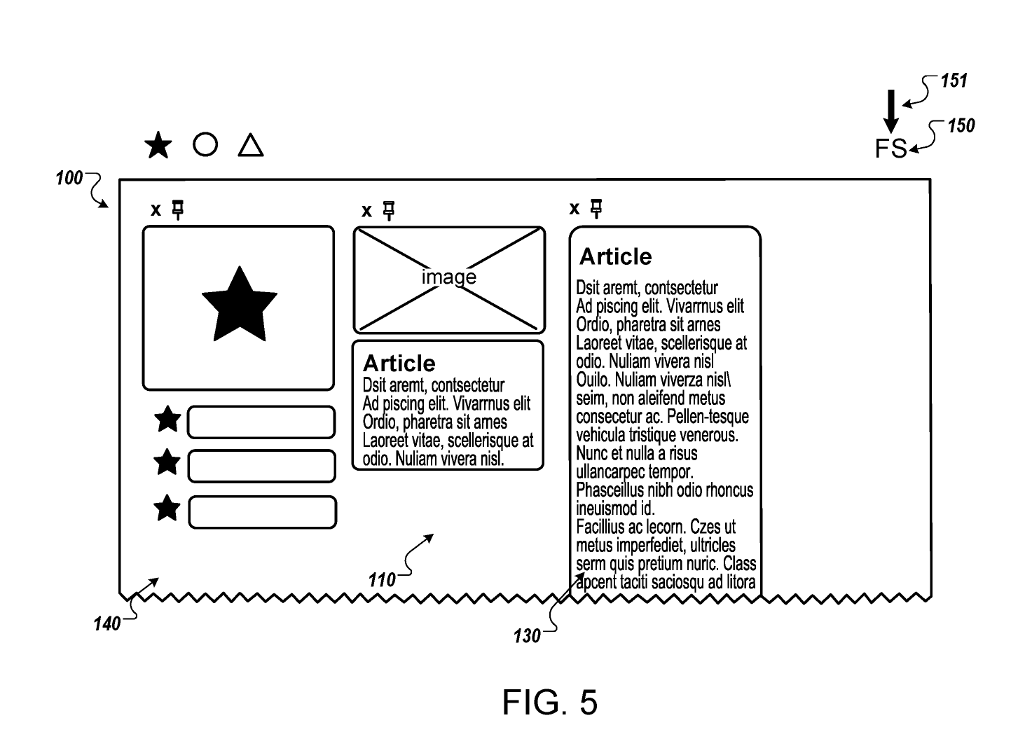

FIG. 5 illustrates the example user interface 100 as the user is submitting an input 151 to invoke an expansion control 150. As described above with reference to FIG. 4, in the example of FIG. 5, the starred graphical unit 140 is displayed in the first position, the first graphical element 110 is displayed in the second position in the horizontal array, and the third graphical element 130 is displayed in the third position in the horizontal array.

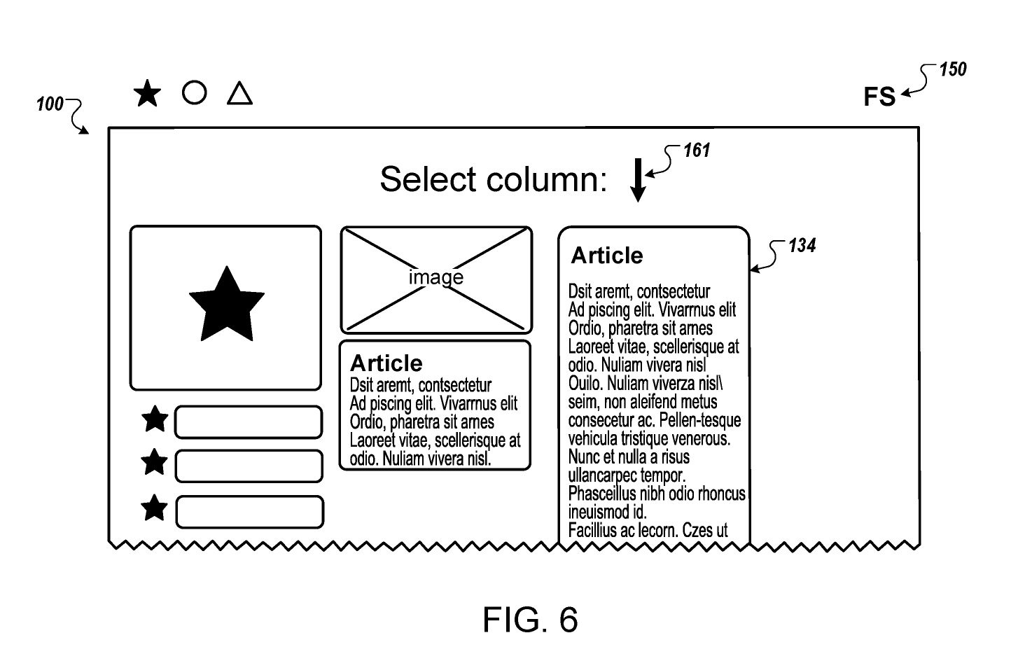

FIG. 6 illustrates the example user interface 100 after the user has submitted the input 151 to invoke the expansion control 150. The user device has modified the user interface 100 to display a “Select column” prompt to indicate to the user that invoking a content item will result in the display size of the content item being increased. In response to the prompt, the user has submitted an input 161 invoking the article content item 134. In some implementations other than those illustrated in FIG. 6, the user interface 100 allows the user to invoke a content item to increase the display size of the content item without displaying the prompt. Additionally, in some implementations, instead of or in addition to displaying the prompt, the system may visually alter the expansion control 150 to indicate that the user has invoked the expansion control 150.

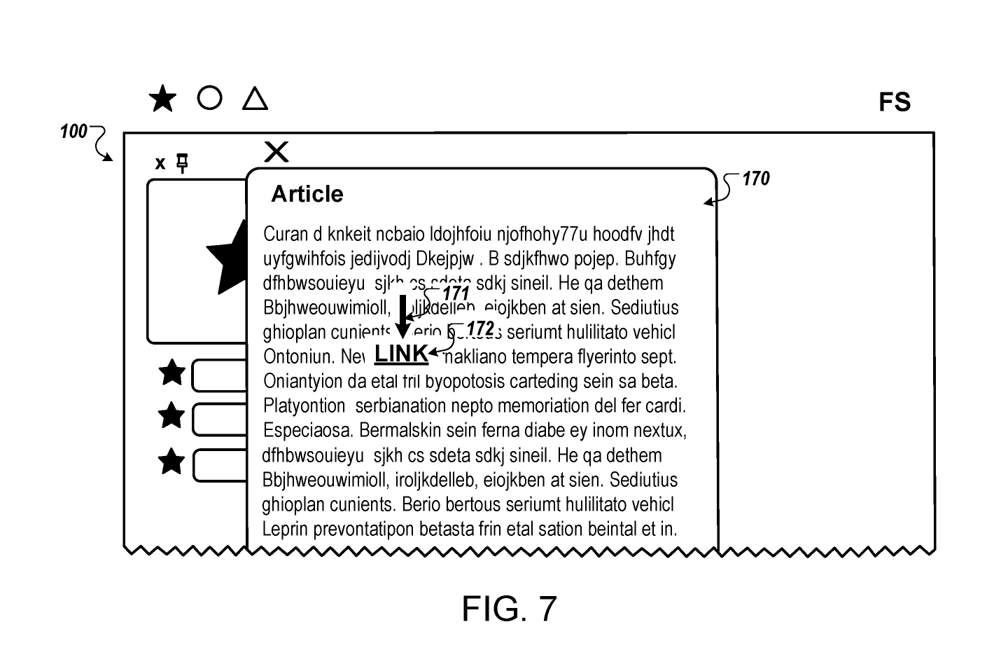

FIG. 7 illustrates the example user interface 100 with an enlarged version 170 of the article content item 134 being displayed. The user device has modified the user interface 100 to overlay the enlarged version 170 of the article content item 134 over the displayed graphical units in response to the user submitting the input 161 to invoke the article content item 134. While the enlarged version 170 is overlaid over the graphical units in the user interface 100, a portion of the graphical units may remain visible, e.g., a portion of the starred graphical unit 140 in the first position in the horizontal array.

While viewing an enlarged content item, the user may desire to navigate away from the enlarged content item to view another content item. For example, the user may desire to follow a link 172 in the enlarged version 170 and may submit an input 171 invoking the link 172. In various implementations, the user interface may allow the user to enlarge certain content items, e.g., photos and articles, or may allow the user to only enlarge entire graphical units.

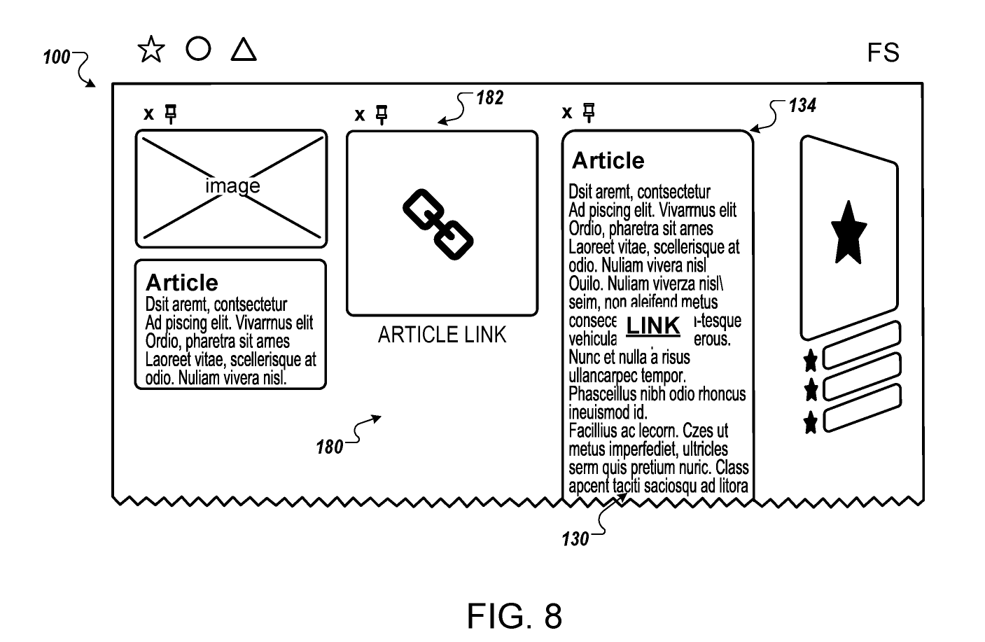

FIG. 8 illustrates the example user interface 100 after the user has submitted the input 171 invoking the link 172. In response to the user invoking the link 172, the user device has modified the user interface 100 to revert the enlarged version 170 to the article content item 134 in the graphical unit 130. The user device has also displayed a fourth graphical unit 180 in the second position in the horizontal array. Because the fourth graphical unit 180 was displayed as a result of the user invoking the link 172, the fourth graphical unit 180 includes a linked content item 182 that displays the content linked to by the link 172. In particular, because the fourth graphical unit 180 was displayed in response to a user input associated with the graphical unit 130, the fourth graphical unit 180 is displayed adjacent to the graphical unit 130. Moreover, because all positions in the horizontal array other than the recently closed position were filled when the user submitted the input and the position of the invoked graphical unit 130 remains fixed, to allow the fourth graphical unit to be displayed adjacent to the invoked graphical unit 130, the starred graphical unit 140 has been moved to the recently closed position and the first graphical unit 110 has been pushed to the first position in the horizontal array.

When a user has finished interacting with a graphical unit, the user can invoke a close control contained in the graphical unit to move the graphical unit to the recently closed position in the horizontal array or, if no recently closed position is displayed, to relocate the graphical unit out of the horizontal array so that it is no longer displayed. In some implementations, in addition to or instead of the close control, when the user interface 100 is displayed on a user device that supports gesture inputs, a predetermined gesture, e.g., a swipe right, a swipe left, or a swipe down gesture, can offer the same functionality as the close control. Additionally, some graphical units may contain a cancel control instead of or in addition to a close control. In response to the user invoking the cancel control, the graphical unit is automatically removed from the array, even if the array includes a recently closed position.

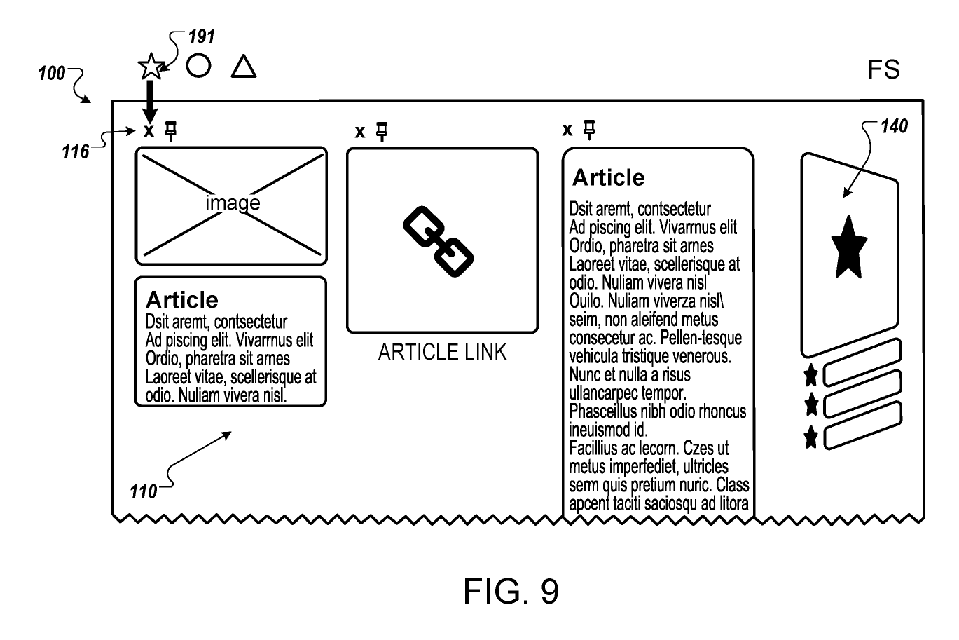

FIG. 9 illustrates the example user interface 100 as the user is submitting an input 191 on the close control 116 in the first graphical unit 110. Before the user has submitted the input 191, the first graphical unit 110 is displayed in the first position in the horizontal array and the starred graphical unit 140 is displayed in the recently closed position in the horizontal array with a reduced graphical prominence.

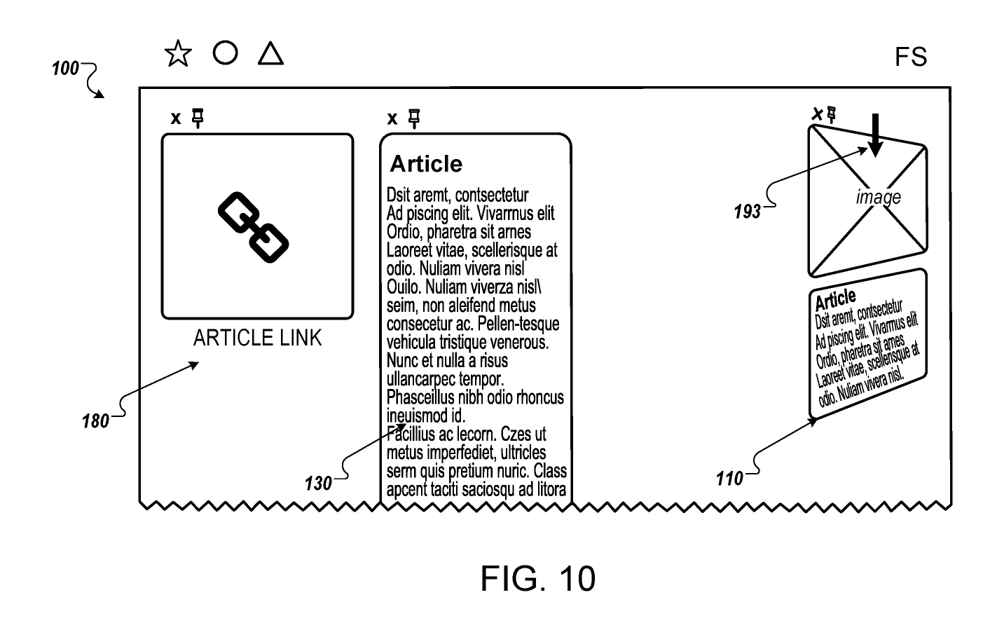

FIG. 10 illustrates the example user interface 100 after the user has submitted the input 191 to invoke the close control 116 in the first graphical unit 110. As a result of the user invoking the close control 116, the user device has moved the first graphical unit 110 to the recently closed position and has relocated the starred graphical unit 140 out of the horizontal array so that it is no longer displayed in the user interface 100. Because the first graphical unit 110 is now displayed in the recently closed position, the graphical prominence of the first graphical unit 110 has been reduced relative to the other displayed graphical units. Additionally, the user device has shifted the fourth graphical unit 180 to the first position in the horizontal array and the third graphical unit 130 to the second position to account for the graphical unit previously in the first position having been moved to the recently closed position.

Although the first graphical unit 110 is now displayed in the recently closed position, the user may nonetheless desire to revert the first graphical unit 110 to one of the other positions in the horizontal array, e.g., because the user moved the first graphical unit 110 to the recently closed position in error or once again wishes to interact with the items in the first graphical unit 110.

In the example of FIG. 10, the user has submitted an input 193 on the first graphical unit 110 while the first graphical unit 110 is being displayed in the recently closed position. Generally, in response to a user input invoking a graphical unit that is in the recently closed position, the user device moves the recently closed graphical unit to the lowest empty position in the array or, if there are no empty positions, moves the recently closed graphical unit to the highest non-recently closed position in the array.

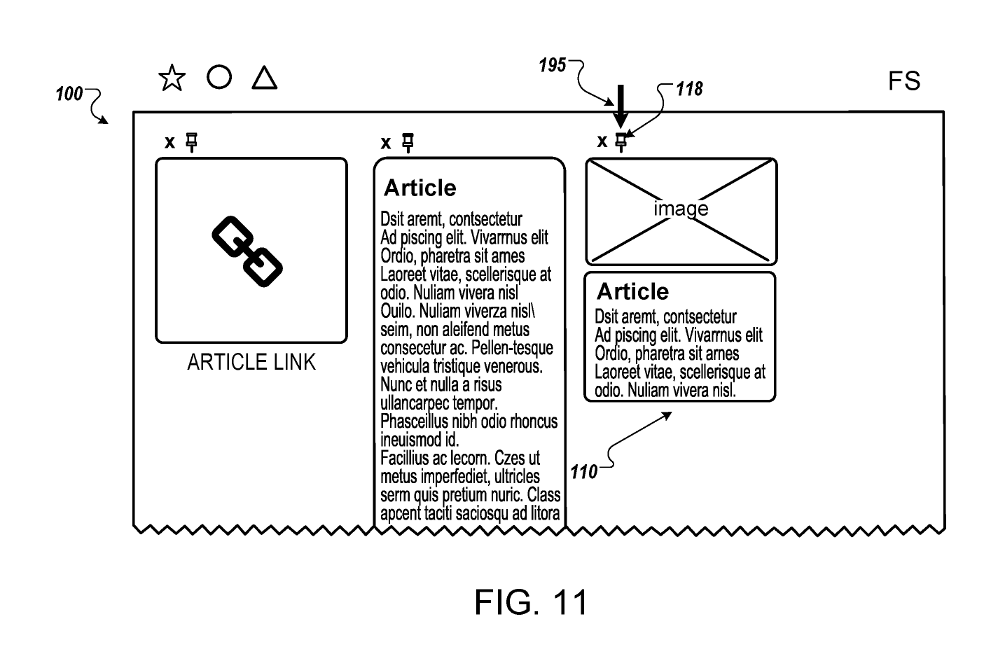

FIG. 11 illustrates the example user interface 100 with the first graphical unit 110 having been reverted to the third position in the horizontal array. That is, in response to the user invoking the first graphical unit 110, the user device has modified the user interface 100 to display the first graphical unit 110 in the third position and to restore the graphical prominence of the first graphical unit 110. By allowing a user to restore a graphical unit that was recently closed, the user device prevents the user from losing partially drafted work, for example, or having to navigate through the interface to re-open the recently closed graphical unit.

In some cases, the user may desire to fix the position of one of the displayed graphical units within the horizontal array. For example, the user may submit an input 193 invoking the pin control 118 contained in the first graphical unit 110. In response, the user device may fix the first graphical unit 110 to one of the positions in the horizontal array, e.g., the position in which the first graphical unit 110 is currently displayed or a predetermined position in the array, e.g., the first position. While the position of the first graphical unit 110 is fixed, i.e., while the first graphical unit 110 is pinned to the predetermined position, the user device refrains from shifting the position of the first graphical unit 110 until the user submits another input closing the first graphical unit or unfixing the position of the first graphical unit 110, i.e., unpinning the first graphical unit 110 from the predetermined position.

In some implementations, when invoking a pin control results in the graphical unit being pinned to a predetermined position and there is already a graphical unit in the predetermined position, the user device switches the positions of the fixed graphical unit and the other graphical unit.

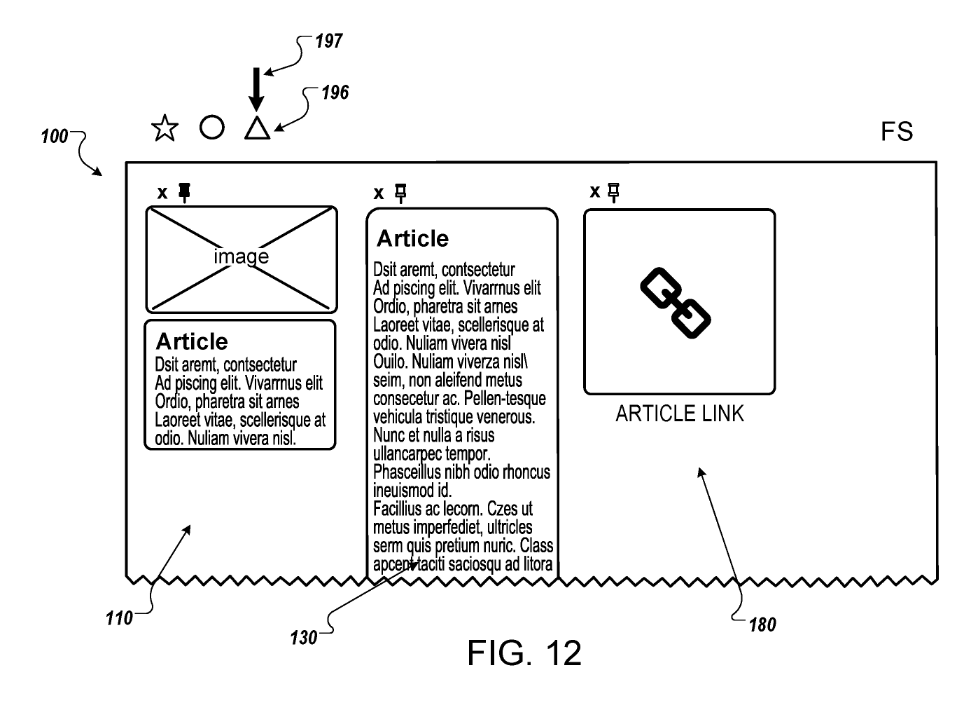

FIG. 12 illustrates the example user interface 100 with the first graphical unit 110 having been pinned to the first position in the horizontal array. In particular, in response to the user invoking the pin control contained in the first graphical unit 110, the user device has switched the positions of the first graphical unit 110 and the fourth graphical unit 180 so that the first graphical unit 110 is now in the first position and the fourth graphical unit 180 is now in the third position while maintaining the third graphical unit 130 in the second position in the array.

In some other implementations, however, rather than switching the positions of the two graphical units, the user device pushes the graphical unit that is in the predetermined position and any graphical units at higher non-recently closed positions than the predetermined positions one position higher in the array and moves the pinned graphical unit to the predetermined position.

In the example of FIG. 12, after the user device has pinned the first graphical unit 110 to the first position, the user has submitted an input 197 invoking a triangle control 196. The triangle control may be associated with a triangle graphical unit that is not currently being displayed in the user interface 100. As described above with reference to the starred graphical unit 140 of FIG. 4, when the triangle control 196 is invoked when no graphical unit is pinned to the first position in the user interface 100, the user device displays the triangle control 196 in the first position. However, in the example of FIG. 12, because the first graphical unit 110 is already pinned to the first position when the triangle control is invoked, the user device processes the request to display the triangle graphical unit differently.

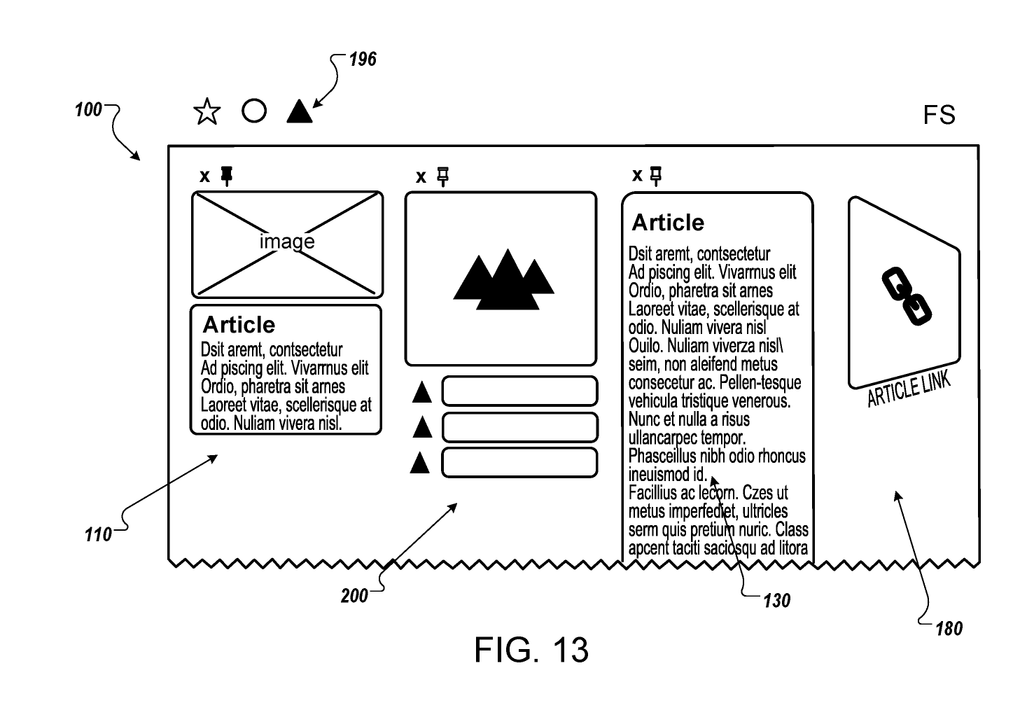

FIG. 13 illustrates the example user interface 100 with a triangle graphical unit 200 being displayed in the second position in the horizontal array. In particular, because the first graphical unit 110 was already pinned to the first position when the triangle control was invoked, the user device has displayed the triangle graphical unit 200 in the next highest position in the array, i.e., the second position, and has pushed each other displayed graphical unit one position higher in the horizontal array. Thus, the third graphical unit 130 is now displayed in the third position in the array and the fourth graphical unit 180 is now displayed in the recently closed position.

In addition, the user device has modified the appearance of the triangle control 196 to indicate to the user that the triangle graphical unit 200 is presently displayed.

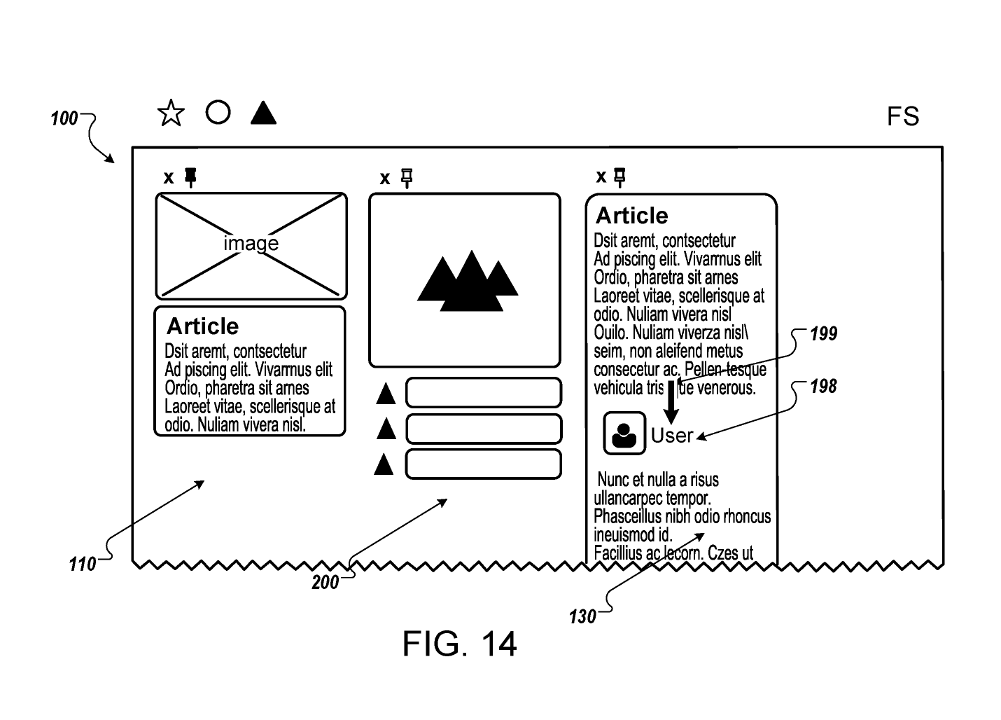

FIG. 14 illustrates the example user interface 100 with the first graphical unit 110 pinned to the first position in the array, the triangle graphical unit 200 being displayed in the second position in the array, and the third graphical unit 130 being displayed in the third position in the array.

In particular, in the example of FIG. 14, the user has submitted an input 199 invoking a user link 198 in the third graphical unit 130. The user link 198 may be a link that, when invoked, causes another graphical unit, e.g., a user graphical unit, to be displayed that provides more information about a particular user.

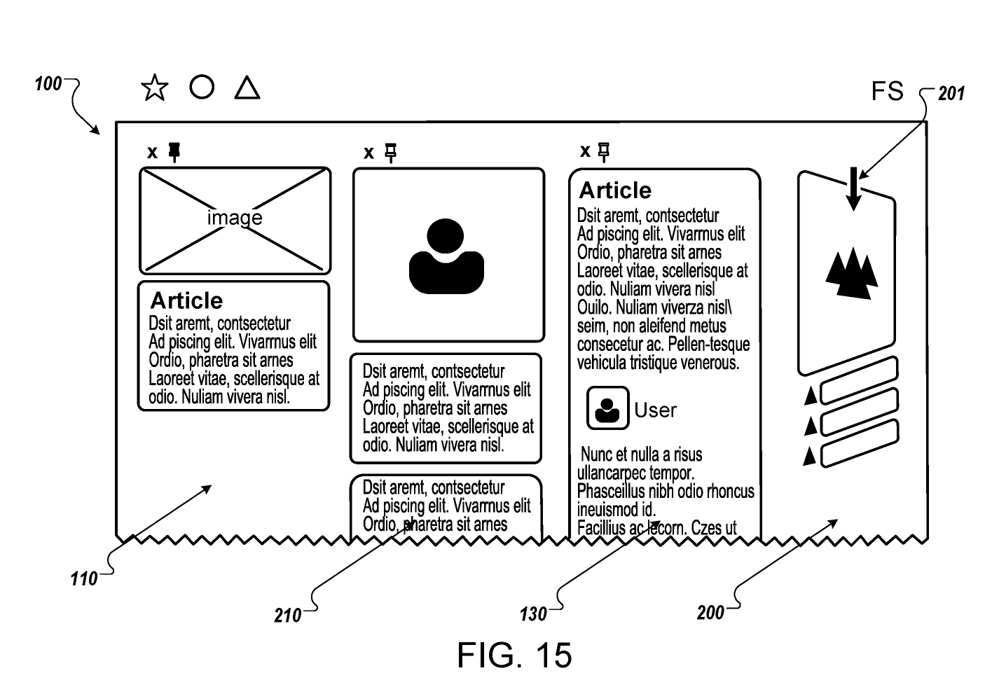

FIG. 15 illustrates the example user interface 100 with a user graphical unit 210 being displayed in the second position in the horizontal array. In particular, because the input 199 was submitted when the first graphical unit 110 was pinned to the first position, the user device has displayed the user graphical unit 210 in the next lowest position from the third graphical unit 130 and has moved the triangle graphical unit 200 to the recently closed position. That is, instead of shifting the triangle graphical unit 200 to the first position and the first graphical unit 110 to the recently closed position, because the first graphical unit 110 is pinned to the first position the user device has instead kept the first graphical unit 110 in the first position and moved the triangle graphical unit 200 to the recently closed position.

In the example of FIG. 15, the user has submitted an input 201 invoking the triangle graphical unit 200 while the triangle graphical unit 200 is in the recently closed position in order to restore the triangle graphical unit 200.

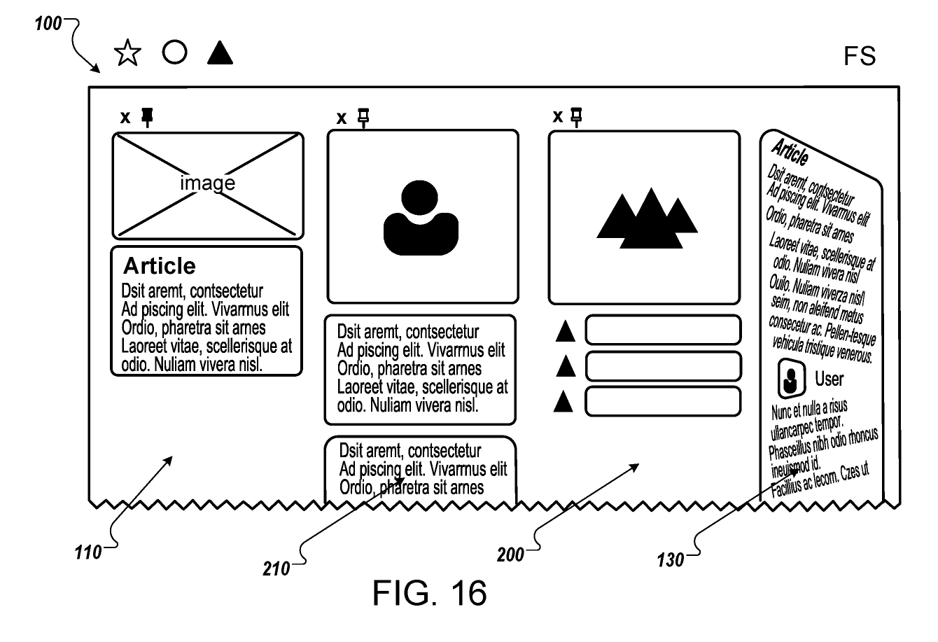

FIG. 16 illustrates the example user interface 100 with the triangle graphical unit 200 displayed in the third position in the horizontal array and the third graphical unit 130 displayed in the recently closed position.

In particular, in response to the input 201, the user device has moved the triangle graphical unit 200 to the highest non-recently closed position in the horizontal array—in this case, the third position—and has moved the graphical unit previously in the highest non-recently closed position in the horizontal array—in this case, the third graphical unit 130—to the recently closed position.

In some cases, a user may submit an invalid input while the user interface is being displayed on the user device. For example, a user may submit an input that attempts to open a graphical unit that is already being displayed. In response, the user device may cause the graphical unit that is already open to make an anthropomorphic gesture, e.g., bouncing up slightly, or shaking back and forth. As another example, if the user tries to take an action that is not possible, e.g., to enlarge a content item when the functionality to enlarge the content item is unavailable, the user device may cause the relevant graphical unit to make an anthropomorphic gesture, e.g., shaking back and forth decisively.

While not shown in the examples illustrated in FIGS. 1-16, in some implementations and for some or all of the graphical units displayed in the user interface at a given time, a user may be able to invoke a control or content item in a given graphical unit or otherwise interact with the graphical unit to cause the user device to update the content of the graphical unit without altering the display characteristics of any of the other graphical units being displayed. For example, a graphical unit may have a “refresh” control that, when invoked by a user, causes the user device to obtain a new instance of the content displayed in the graphical unit and replace the currently display content with the new content. As another example, a graphical unit may have a “back” control that, when invoked by a user, allows the user to navigate back by causing the user to display content that was previously displayed in the graphical unit. As another example, the “back” control may be used to revert only a portion of the content within the graphical unit to a prior state, e.g., to allow a user to navigate between sub-menus within the same graphical unit, eliminating the need to display a separate graphical unit for each invocation of any sub-menu by the user.

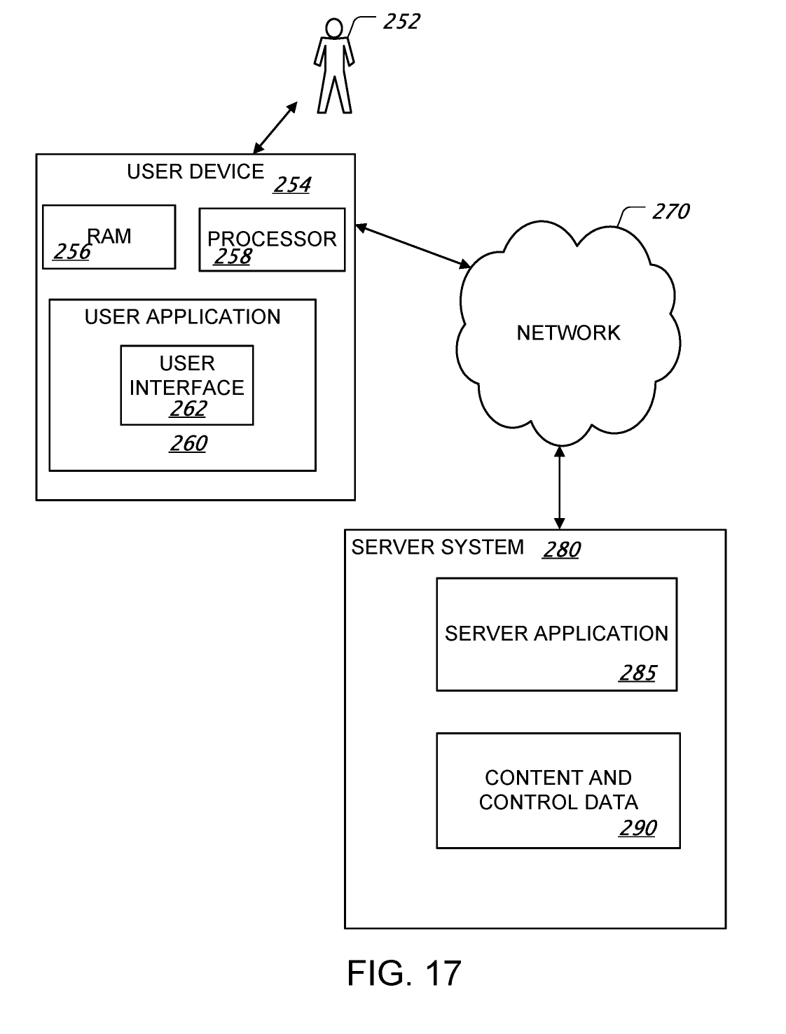

FIG. 17 shows an example user device 254 and an example server system 280.

A user 252 can interact with the server system 280 through the user device 254. The user device 254 will generally include memory, e.g., a random access memory (RAM) 256, for storing instructions and data and a processor 258 for executing stored instructions. The memory can include both read only and writable memory. For example, the user device 254 can be a computer, e.g., a laptop computer, a desktop computer, a smartphone or other mobile device, a tablet computer, and so on, coupled to the server system 280 through a data communication network 270, e.g., local area network (LAN) or wide area network (WAN), e.g., the Internet, or a combination of networks, any of which may include wireless links.

Generally, the server system 280 provides a user interface 262 to the user device 254 through which the user 252 can interact with the server system 280. For example, the server system 280 can provide the user interface 262 in the form of a web page that is rendered by a user application 260 running on the user device 254 and displayed to the user 252 in a window or tab of the user application 260. The user application 260 may be, e.g., a web browser, an app installed on the user device 254, e.g., on a mobile device, or other user application capable of rendering and displaying the user interface 262 on the user device 254. In some implementations, the user application 260 may be a virtual reality or augmented reality environment running on the user device 254.

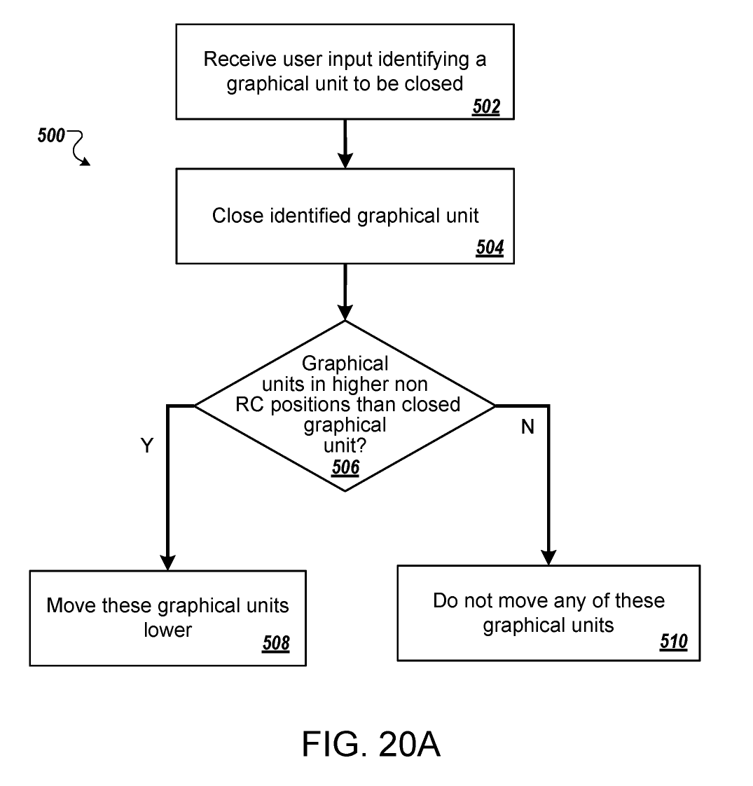

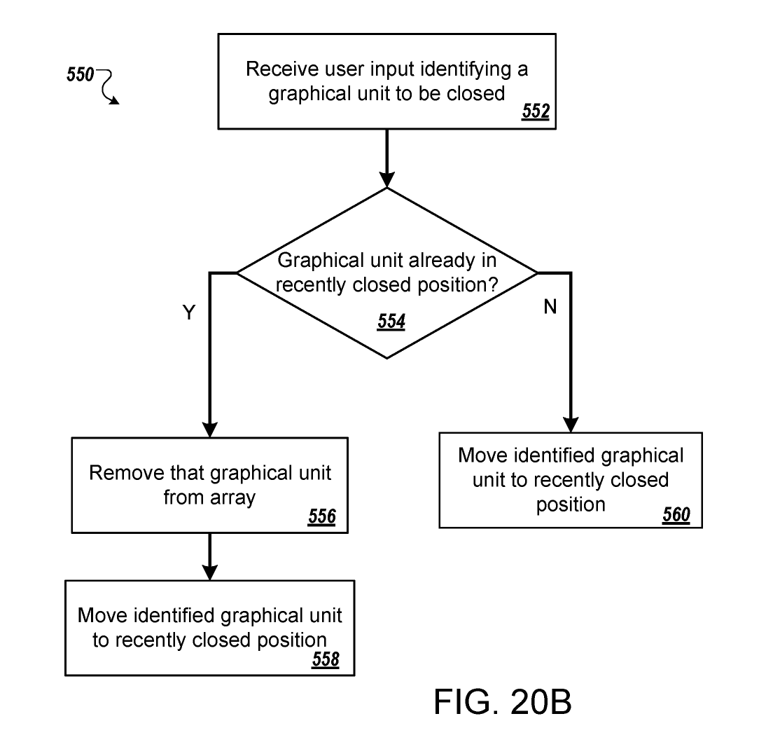

The server system 280 is an example of a system implemented as computer programs on one or more computers in one or more locations and operates a server application 285 that provides content and control data 290 over the network 270 to the user device 254 for presentation 262. In particular, the server application 280 provides instructions over the network 270 to the user device 254 that cause the user application 260 to display a user interface, i.e., the user interface 262, that allows the user 252 to view and interact with the content and control data 290 as described above with reference to FIGS. 1-16 and below with reference to FIGS. 20A-23.

The server system 280 may provide the content and control data 290 for presentation on different types of user devices, including handheld mobile devices, non-handheld mobile devices, and non-mobile devices. For each of the user devices, the instructions provided by the server application 285 to the user device cause the user device to display, in the user interface and at a given time, a number of graphical units in the horizontal array that depends on a size of the display screen of the user device.

In some implementations, the server application 280 may have been initially created to generate and serve content and controls associated with the user application as graphical units to handheld mobile devices, and may later be used to serve the content and controls associated with the user application to non-handheld devices.

Additionally, the instructions provided by the server application 280 to the user devices may, as described above, enable each of the devices to alter the number of graphical units that are displayed in the horizontal array at a given time based on available space on display screens of the devices or on available space in dynamically alterable sizes of windows or tabs of web browsers or augmented reality environments or virtual reality environments running on the devices.

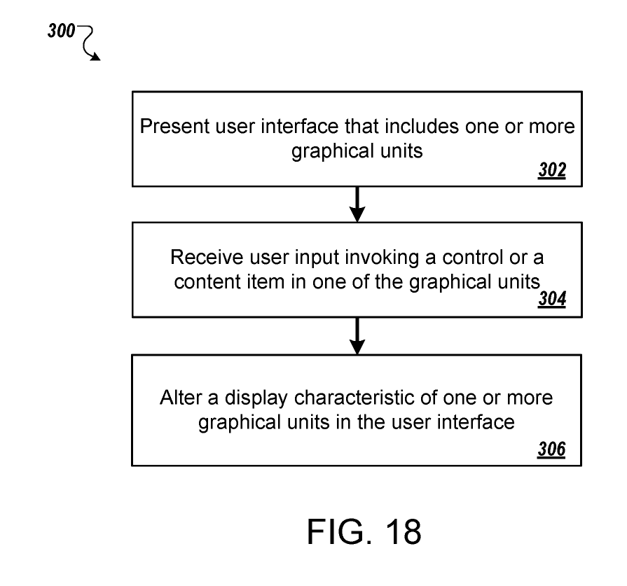

FIG. 18 is a flow diagram of an example process 300 for altering a display characteristic of a graphical unit in a user interface. A user device, e.g., the user device 254 of FIG. 17, appropriately programmed in accordance with this specification, can perform the process 300.

The user device presents a user interface that includes one or more graphical units (step 302). Each of the graphical units contains one or more items, e.g., one or more controls, one or more content items, or both. The user device may present the user interface as a result of instructions received from a server computer system, e.g., the server computer system 280 of FIG. 17, and the user interface may allow a user to interact with content items served by the server computer system.

The user device receives a user input invoking a control or a content item in one of the one or more graphical units (step 304).

In response, the user device alters a display characteristic of one or more graphical units in the user interface (step 306). As described above in the examples of FIGS. 1-16 and below with reference to FIGS. 20A-23, depending on the user input and on the content item that was invoked, the input may cause the user device to alter a display characteristic of one or more graphical units, e.g., of the graphical unit in which the control or content item was invoked or of one or more other graphical units, in any of a variety of ways.

For example, some inputs may cause the user device to display a graphical unit in the user interface that was not displayed prior to the user input. As another example, some inputs may cause the user device to alter a graphical prominence of another graphical unit. As yet another example, some inputs may cause the user device to move one or more graphical units to different positions in the user interface. As yet another example, some inputs may cause the user device to display a new graphical unit in the user interface and to move one or more other, already displayed graphical units to different positions in the user interface. As yet another example, some inputs may cause the user device to remove a graphical unit from the user interface.

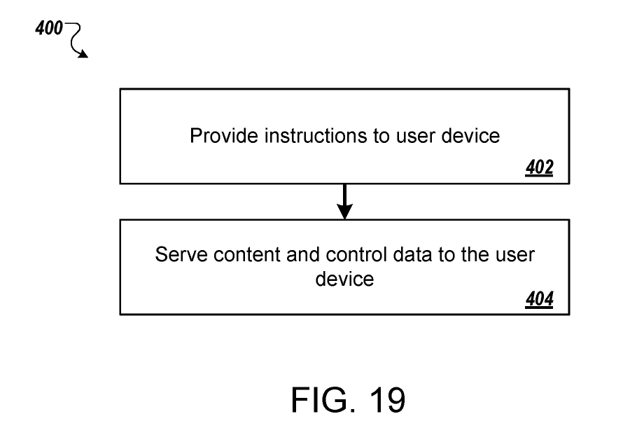

FIG. 19 is a flow diagram of an example process 400 for serving content and control data to a user device. For convenience, the process 400 will be described as being performed by a system of one or more computers located in one or more locations. For example, a server system, e.g., the server system 280 of FIG. 17, appropriately programmed in accordance with this specification, can perform the process 400.

The system provides instructions to a user device that cause the user device to display a user interface (step 402). In particular, the instructions, when executed by the user device, cause the user device to present a user interface and to modify the user interface in response to user inputs as described above with reference to FIGS. 1-16 and below with reference to FIGS. 20A-23.

While the user interface is displayed, the system serves content and control data to the user device (step 404). That is, as the user navigates through the user interface and causes the user device to display new graphical units in the user interface, the system provides the content and control data necessary to populate the new graphical units.

FIG. 20A is a flow diagram of an example process 500 for altering a user interface in response to a user input identifying a graphical unit to be closed. A user device, e.g., the user device 254 of FIG. 17, appropriately programmed in accordance with this specification, can perform the process 500.

The user device receives a user input identifying a displayed graphical unit to be closed (step 502). For example, a user may submit an input invoking a close control in the graphical unit or submit a different kind of input closing the graphical unit, e.g., by performing a swipe down gesture on the graphical unit.

The user device closes the identified graphical unit (step 504). Closing the identified graphical unit will be described in more detail below with reference to FIG. 20B.

The user device determines whether one or more graphical units—other than any graphical unit in the recently closed position—exist in positions higher in the horizontal array than the position of the closed graphical unit (step 506).

If so, the user device shifts each graphical unit—other than any graphical unit in the recently closed position—that is in a position higher than the position of the closed graphical unit one position lower in the horizontal array (step 508).

If no graphical units—other than any graphical unit in the recently closed position—exist in positions higher in the array than the position of the closed graphical unit, the user device refrains from moving any of these graphical units to different positions in the horizontal array (step 510).

FIG. 20B is a flow diagram of an example process 550 for closing a graphical unit. A user device, e.g., the user device 254 of FIG. 17, appropriately programmed in accordance with this specification, can perform the process 550.

The user device receives a user input identifying a graphical unit to be closed (step 552).

The user device determines whether, when the user input identifying the graphical unit to be closed is received, a graphical unit exists in the recently closed position of the horizontal array (step 554).

If a graphical unit exists in the recently closed position, the user device removes that graphical unit from the horizontal array, i.e., relocates the graphical unit out of the array (step 556).

The user device then moves the graphical unit to be closed to the recently closed position (step 558). As described above, in some implementations, the user device alters the prominence of the identified graphical unit as part of moving the identified graphical unit to the recently closed position in the horizontal array.

If no graphical unit existed in the recently closed position, the user device moves the identified graphical unit to the recently closed position (step 560).

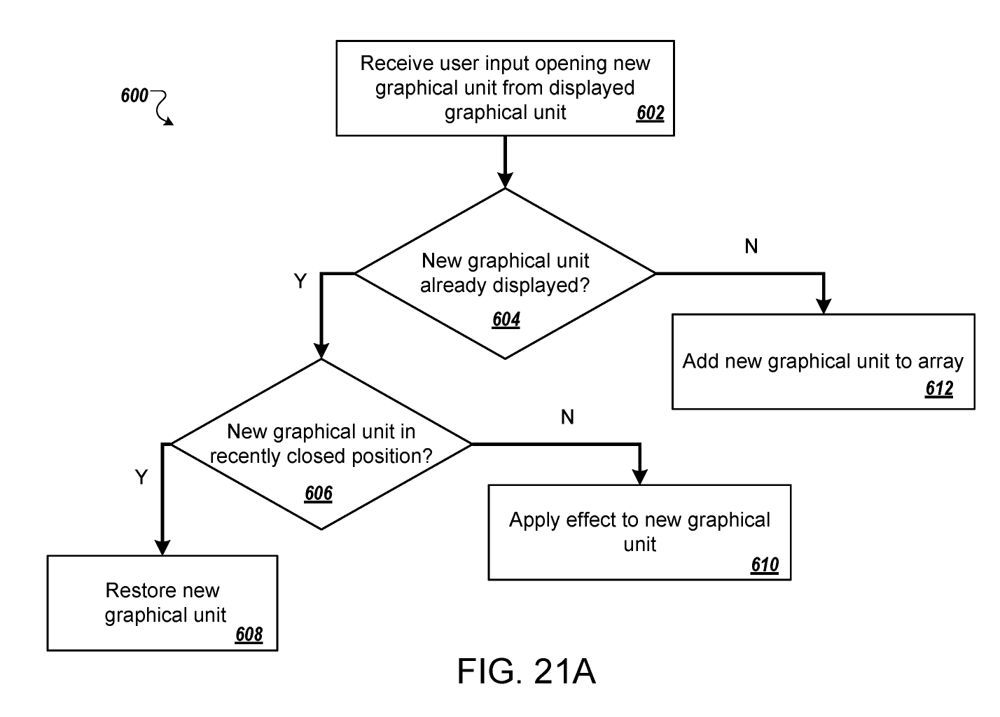

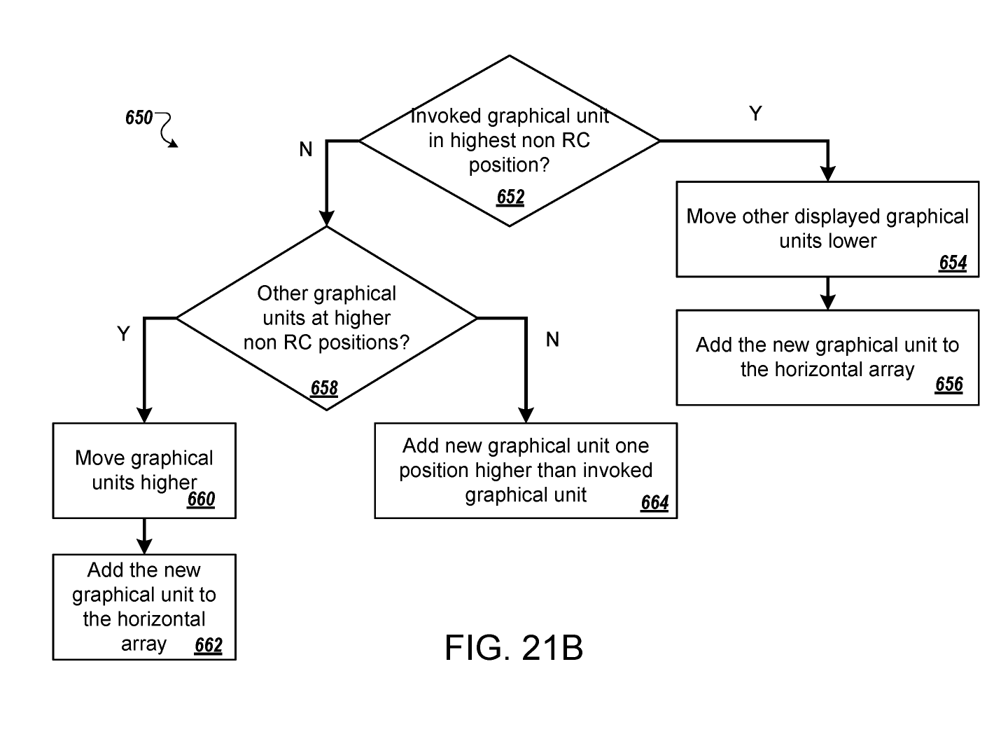

FIG. 21A is a flow diagram of an example process 600 for altering a user interface in response to a user input opening a new graphical unit from a displayed graphical unit. A user device, e.g., the user device 254 of FIG. 17, appropriately programmed in accordance with this specification, can perform the process 600.

The user device receives a user input opening a new graphical unit from a displayed graphical unit (step 602). That is, a user may have invoked a content item or a control within the displayed graphical unit that results in a new graphical unit being displayed.

The user device determines whether the new graphical unit associated with the invoked content item or control is already displayed in the user interface (step 604). For example, in some cases, the user may attempt to cause the user device to display a new graphical unit associated with the invoked content item or control even though that graphical unit is already being displayed.

If the new graphical unit is already displayed in the user interface, the user device determines whether the new graphical unit is displayed in the recently closed position in the horizontal array (step 606).

If the new graphical unit is already displayed in the recently closed position, the user device restores the new graphical unit, i.e., moves the new graphical unit to a different position in the horizontal array that is not the recently closed position (step 608).

In particular, to restore the new graphical unit if a graphical unit is already displayed in the highest non-recently closed position in the array, the user device opens the new graphical unit in the highest non-recently closed position and moves the graphical unit that was previously in the highest non-recently closed position to the recently closed position. If there is not already a graphical unit in the highest non-recently closed position in the array, the user device moves the new graphical unit to the lowest empty position in the array.

If the new graphical unit is displayed in a position other than the recently closed position, the user device applies an effect to the new graphical unit, i.e., to indicate to the user that the new graphical unit is already displayed (step 610). For example, the user device may cause the graphical unit that is already open to make an anthropomorphic gesture, e.g., bouncing up slightly, or shaking back and forth.

If the new graphical unit is not already displayed in the user interface, the user device adds the new graphical unit to the array (step 612). Adding a new graphical unit to the array in response to a user invoking a content item or control in an existing graphical unit is described in more detail below with reference to FIG. 21B.

FIG. 21B is a flow diagram of an example process 650 for adding a new graphical unit to the horizontal array in response to a user invoking a displayed graphical unit. A user device, e.g., the user device 254 of FIG. 17, appropriately programmed in accordance with this specification, can perform the process 650.

The user device determines whether the invoked graphical unit is in the highest non-recently closed position in the array (step 652).

If the invoked graphical unit is in the highest non-recently closed position in the array, the user device moves each displayed graphical unit—other than (i) the invoked graphical unit, (ii) any graphical unit in the recently closed position, and (iii) any pinned graphical unit—one position lower in the horizontal array (step 654).

The user device then adds the new graphical unit to the position immediately lower than the position of the invoked graphical unit in the horizontal array if such a position is not occupied by a pinned graphical unit (step 656).

If the position immediately lower than the highest non-recently closed position in the array is occupied by a pinned graphical unit, the user device moves the invoked graphical unit to the recently closed position and removes any graphical unit previously in the recently closed position from the array. The user device then adds the new graphical unit to the array in the highest non-recently closed position in the array.

Stated differently, if there is no room to add the new graphical unit to the array in the position adjacent to and immediately lower than the position of the invoked graphical unit due to a pinned column occupying that position, then the invoked graphical unit is moved to the recently closed position, and the new graphical unit takes its place.

To move the displayed graphical units other than the invoked graphical unit, any graphical unit in the recently closed position, and any pinned graphical unit lower in the array, the user device moves the graphical that is in the lowest position in the array, e.g., the graphical unit previously in the first position in the array, to the recently closed position and then moves each other graphical unit displayed in positions lower than the invoked graphical unit one position lower in the horizontal array.

If there is a graphical unit pinned to the first position in the horizontal array, the user device does not move the pinned display graphical unit and instead moves the lowest-position graphical unit that is not pinned, such as the graphical unit previously at the second position in the array, to the recently closed position and then moves each other graphical unit displayed in positions lower than the invoked graphical unit one position lower in the horizontal array.

If the invoked graphical unit is not in the highest non-recently closed position in the array, the user device determines whether any other graphical units are displayed in higher non-recently closed positions in the array than the position of the invoked graphical unit (step 658).

If other graphical units are displayed in higher non-recently closed positions in the array than the position of the invoked graphical unit, the user device moves each of these graphical units one position higher in the array (step 660). If there was a graphical unit displayed in the highest non-recently closed position in the array, the user device moves that graphical unit to the recently closed position.

The user device then adds the new graphical unit to the horizontal array in the position that is one position higher than the position of the invoked graphical unit in the horizontal array (step 662).

If no other graphical units are displayed in higher non-recently closed positions than the position of the invoked graphical unit, the user device adds the new graphical unit in the position one position higher in the array than the position of the invoked graphical unit, i.e., without needing to move the position of any of the other displayed graphical units (step 664).

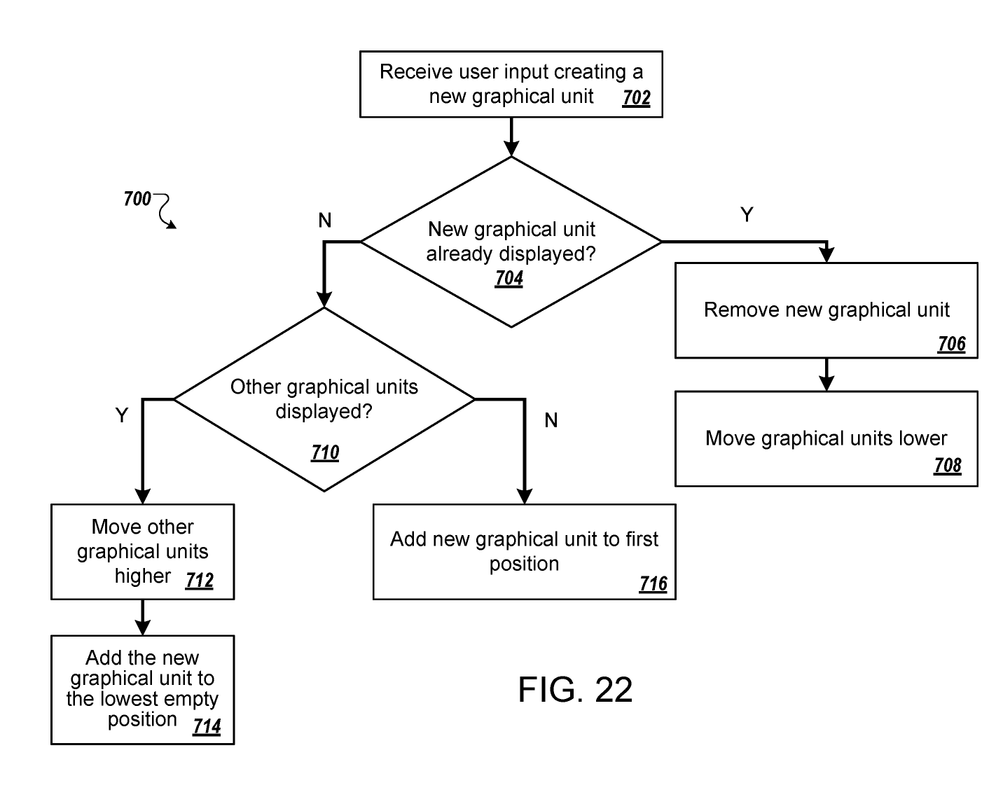

FIG. 22 is a flow diagram of an example process 700 for adding a new graphical unit to the horizontal array in response to a user invoking a control that is not contained in a graphical unit. A user device, e.g., the user device 254 of FIG. 17, appropriately programmed in accordance with this specification, can perform the process 700.

The user device receives a user input creating a new graphical unit (step 702). In particular, the user input is not initiated within any displayed graphical unit. For example, the user input may be an input invoking a control in a menu in the user interface. As another example, the user input may be an input invoking a notification presented in the user interface.

The user device determines whether the new graphical unit is already displayed in the user interface (step 704).

If the new graphical unit is already displayed, the user device removes this graphical unit from the horizontal array, i.e., relocates this graphical unit out of the array (step 706).

The user device then moves each graphical unit—other than any graphical unit in the recently closed position—that is in a position higher than the position of the removed graphical unit one position lower in the array (step 708).

In some implementations, if the new graphical unit is already displayed, the user device indicates to the user that the new graphical unit is already displayed, e.g., by causing the new graphical unit to make an anthropomorphic gesture, e.g., bouncing up slightly, or shaking back and forth, instead of removing the graphical unit from the horizontal array.

If the new graphical unit is not already displayed in the user interface, the user device determines whether any other graphical units are already displayed in the user interface (step 710).

If at least one other graphical unit is already displayed in the user interface, the user device moves each non-pinned displayed graphical unit one position higher in the array (step 712). If a graphical unit is displayed in the highest non-recently closed position in the array, the user device moves that graphical unit to the recently closed position.

The user device then adds the new graphical unit to the lowest empty position in the array (step 714).

If no other graphical units are displayed, the user device adds the new graphical unit to the first position in the horizontal array (step 716).

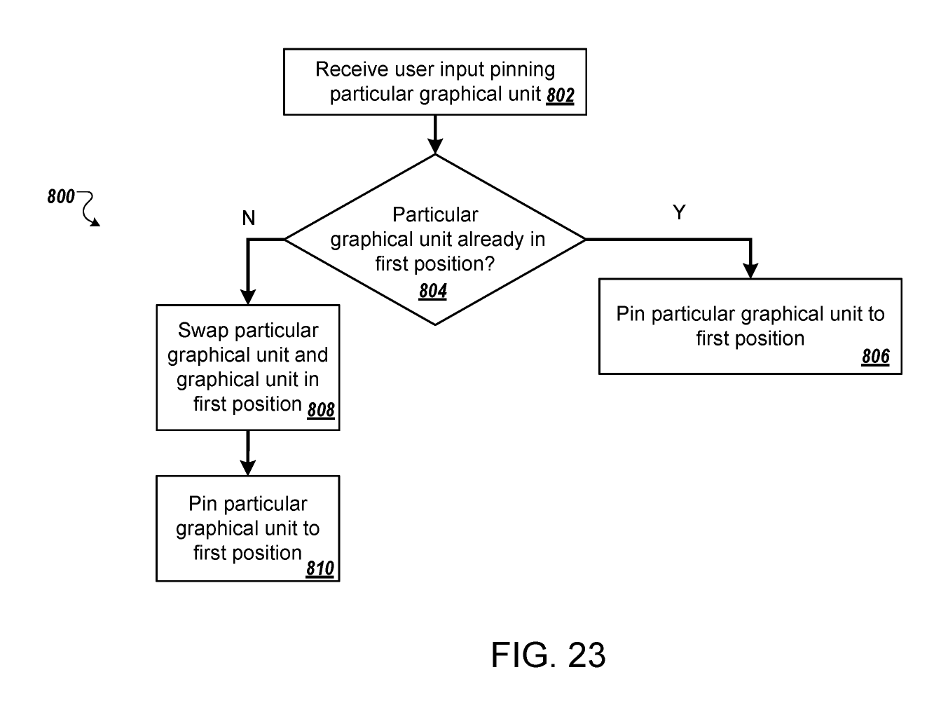

FIG. 23 is a flow diagram of an example process 800 for pinning a graphical unit to the first position in the horizontal array. A user device, e.g., the user device 254 of FIG. 17, appropriately programmed in accordance with this specification, can perform the process 800.

The user device receives a user input pinning a particular a particular displayed graphical unit (step 802). For example, the user may submit an input invoking a pin control contained in the particular graphical unit.

The user device determines whether the particular graphical unit is already displayed in the first position of the horizontal array (step 804).

If the particular graphical unit is already displayed in the first position of the horizontal array, the user device pins the particular graphical unit to this position (step 806). In some implementations, if the user device determines that the particular graphical unit has already been pinned, the user device unpins the particular graphical unit.

If the particular graphical unit is not already displayed in the first position, the user device simultaneously moves the position of the graphical unit previously in the first position to the position of the particular graphical unit at the time the user input pinning the particular graphical unit was received, and moves the position of the particular graphical unit to the first position in the horizontal array (step 808). Stated differently, the user device swaps the positions of the particular graphical unit and the graphical unit in the first position in the horizontal array. If the graphical unit previously displayed in the first position in the horizontal array was pinned to that position, the user device unpins that graphical unit from the first position.

The user device then pins the particular graphical unit to the first position in the array (step 810).

The descriptions of FIGS. 20-23 describe moving graphical units to higher and lower positions in the horizontal array. As described above with reference to the example of FIGS. 1-16, in some implementations, the first position, i.e., the lowest position, in the horizontal array is the leftmost position in the array and subsequent, i.e., higher, positions incrementally move to the right across the user interface. In some other implementations, however, the first position is the rightmost position in the array and higher positions incrementally move to the left across the user interface.

Moreover, the above description describes the first position, i.e., the lowest position, in the array being either the far left position in the array or the far right position in the array. In some other implementations, however, the first position in the array may be the position that is in the center of the array, i.e., is in the center of the user interface.

For example, in some implementations, the user device may be a device capable of generating a virtual reality environment or augmented reality environment in which the user interface may be displayed. In these implementations, rather than being a horizontal array displayed on a two-dimensional plane, the array may be an arc spanning across a portion or all of the user's field of view, i.e., an arc that curves around the user.

Additionally, in these implementations, the first position in the array may be at the center of the arc, i.e., at the center of the user's field of view. Thus, when a user invokes a content item or control that results in a new graphical unit being created in the first position of the array, the user device adds the new graphical unit in the center of the array and one or more currently displayed graphical units are moved along the arc away from the center of the array a sufficient distance to allow the new graphical unit to be positioned at the center of the array. In some cases, when the user creates the new graphical unit by invoking an existing graphical unit, the user device may display the new graphical unit on the edge of the invoked graphical unit that is nearest to the center of the array rather than positioning the new graphical unit at the center of the array.

Further, in some of these implementations, the recently closed position or positions may be at one or both edges of the arc, or may be displayed above or below the other positions in the array, e.g., either very high or very low in the visual field of the user. In cases where the recently closed position is displayed above the other positions, the user can send a graphical unit to the recently closed position by swiping up on the graphical unit and, similarly, in cases where the recently closed position is displayed below the other positions, the user can send a graphical unit to the recently closed position by swiping down on the graphical unit.

In augmented reality or virtual reality implementations, the user device may allow the user to scroll through the graphical units in the arc by performing a predetermined gesture input, e.g., by placing an open palm at one edge of the arc and sweeping the graphical units leftward or rightward.

Additionally, a user may be able to submit a predetermined input to group multiple displayed graphical units. For example, once the graphical units are grouped, an input submitted on one of the grouped graphical units is applied to all of the graphical units in the group, e.g., a gesture input closing the graphical units or moving the graphical units to a different position in the arc. As another example, a group of graphical units may be saved as a group, and later accessed via a link, menu, or other interface element. As yet another example, one or more graphical unit groups could be synchronized (including synchronizing the scroll location within graphical units) across interfaces, either automatically or upon the request of the user.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA or an ASIC.

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for use with one or more processors; memory; and one or more programs stored in the memory and configured to be executed by the one or more processors, the method comprising
within a user interface that comprises at least one of: a single window or a single tab of a web browser or an augmented reality environment or a virtual reality environment, displaying one or more graphical units, at least one of the graphical units visibly encompassing simultaneously three or more content items or controls including at least one content item and at least one control, the items of each of the graphical units being associated with a particular application,
at least two of the graphical units and the content items or controls encompassed by each of the graphical units being displayed sometimes simultaneously in respective positions in a horizontal array within the user interface, the presence or position or both of each of the graphical units in the horizontal array being changeable independently of the presence or position or both of at least another of the graphical units in the horizontal array, and
in response to a user invoking independently each of at least two of the content items or controls of one of the graphical units, at least sometimes adding two corresponding graphical units to the horizontal array.

2. The method of claim 1 in which each of the positions can accommodate zero or one of the graphical units at a given time.

3. The method of claim 1 in which successive relationships of respective graphical units to positions in the horizontal array at successive times is determined at least in part by successive actions of a user with respect to content items or controls of the graphical units.

4. The method of claim 1 in which, in response to the user invoking a control of one of the graphical units, causing the one graphical unit to occupy and then remain in a particular position in the horizontal array.

5. The method of claim 1 comprising, in response to an action by the user or by the user interface, causing one of the graphical units to be moved to a particular position of the horizontal array associated with recently closed graphical units.

6. The method of claim 5 comprising, in response to a user invoking a feature of the user interface, restoring the graphical unit from the position of the horizontal array associated with recently closed graphical units.

7. The method of claim 5 comprising displaying the graphical unit that occupies the position of the horizontal array associated with recently closed graphical units to give the user a visual cue that the graphical unit is no longer part of the main portion of the horizontal array.

8. The method of claim 7 in which the visual cue comprises removing the graphical unit from the user interface based on the amount of available horizontal space.

9. The method of claim 1 in which the user interface comprises an augmented reality or virtual reality user environment in which the positions are arrayed on a curve oriented across a visual field of the user.

10. The method of claim 9 in which the positions include one or more positions that are associated with recently closed graphical units.

11. The method of claim 10 in which the positions that are associated with recently closed graphical units appear at opposite ends of the curve within the visual field of the user.

12. The method of claim 10 in which, in response to a user invoking a control of the user interface to cause a graphical unit to be closed or in response to a lack of sufficient space in the user interface, the graphical unit is moved to one of the positions associated with recently closed graphical units.

13. The method of claim 10 in which, in response to the user invoking a control of the user interface to cause a graphical unit to be closed or in response to a lack of sufficient space in the user interface, the graphical unit is replaced by a text link or other visible element visible below the curve within the visual field in which the graphical units are displayed.

14. The method of claim 1 in which the graphical units comprise columns.

15. The method of claim 1 in which altering a graphical display characteristic of another one of the graphical units comprises causing the other graphical unit to be displayed.

16. The method of claim 15 in which causing the other graphical unit to be displayed comprises causing the other graphical unit to be displayed immediately to the right of or immediately to the left of the one of the graphical units.

17. The method of claim 1 in which altering a graphical display characteristic of another one of the graphical units comprises moving the other graphical unit to a different position within the horizontal array.

18. The method of claim 1 comprising displaying only one of the graphical units of the array on a display surface at a given time.

19. The method of claim 1 comprising displaying a number of the graphical units of the array on a display surface at a given time, the number depending on an available space of the user interface.

20. The method of claim 1 comprising displaying a number of the graphical units of the array on a display surface at a given time, the number depending on a size of the device on which the user interface is provided.

21. The method of claim 1 in which all of the graphical units are associated with a particular application.

22. The method of claim 1 in which at least two of the graphical units are associated respectively with different particular applications.

23. The method of claim 1 in which the particular application comprises a social networking application.

24. The method of claim 1 in which, when one of the content items is invoked by a user, an additional graphical unit is displayed that includes the content item presented more prominently.

25. The method of claim 1 comprising
at a server, operating a server application to generate and serve the content item or the control for each of the items of the graphical units to devices that have display screens, the devices including handheld mobile devices, non-handheld mobile devices, and non-mobile devices,
the graphical units being generated and served in a manner that enables each of the devices to which the graphical units are served to display, at a given time, an automatically determined number of graphical units in the horizontal array.

26. The method of claim 25 comprising initially creating the server application to generate and serve content and controls associated with the user application as graphical units to handheld mobile devices, and using the created server application to serve the content and controls associated with the user application as the same graphical units to non-handheld devices.

27. The method of claim 25 in which the graphical units are served through single windows or single tabs of web browsers or augmented reality environments or virtual reality environments running on the devices.

28. The method of claim 25 in which the graphical units are generated and served in a manner that enables each of the devices to alter the number of graphical units that are displayed in the horizontal array at a given time based on available space on display screens of the devices or on available space in dynamically alterable sizes of windows or tabs of web browsers or augmented reality environments or virtual reality environments running on the devices.

29. (canceled)

30. The method of claim 1 in which graphically altering comprises displaying an additional graphical unit.
